(19) United States
(12) Patent Application Publication
(10) Pub. No.: US 2024/0367973 A1
(43) Pub. Date: Nov. 7, 2024

(54) HYDROGEN SULFIDE PRODUCING DEVICE AND METHOD FOR PRODUCING HYDROGEN SULFIDE

(71) Applicant: FURUKAWA CO., LTD., Tokyo (JP)

(72) Inventors: Hiroki Goto, Tsukuba-shi, Ibaraki (JP); Kazutomi Yamamoto, Tsukuba-shi, Ibaraki (JP)

(73) Assignee: FURUKAWA CO., LTD., Tokyo (JP)

(21) Appl. No.: 18/561,896

(22) PCT Filed: May 25, 2022
(86) PCT No.: PCT/JP2022/021348

§ 371 Date: Nov. 17, 2023

(30) Foreign Application Priority Data
May 31, 2021 (JP) 2021-091943
May 31, 2021 (JP) 2021-091944
May 31, 2021 (JP) 2021-091945

(51) Int. Cl. C01B 17/16

(52) U.S. Cl. CPC C01B 17/162

(57) ABSTRACT

The hydrogen sulfide producing device of the present invention includes a reactor (1-3) having a liquid sulfur filling part (1-2) inside, a mantle heater (1-4) that is a first heating unit for heating liquid sulfur to produce sulfur vapor, and a hydrogen supply pipe (1-5) that is a hydrogen supply member connected to the reactor (1-3), in which an interior of the reactor (1-3) includes a catalyst support member (1-6) provided above the liquid sulfur filling part (1-2) and a heat-insulating member (1-7) provided above the catalyst support member (1-6).

### TECHNICAL FIELD

The present invention relates to a hydrogen sulfide producing device and a method for producing hydrogen sulfide.

### BACKGROUND ART

As a method for producing hydrogen sulfide, a method in which sulfur vapor is generated by heating sulfur placed inside a reaction tank and the generated sulfur vapor and hydrogen gas are reacted with each other has been known. As such a method for producing hydrogen sulfide, for example, a method disclosed in Patent Document 1 (Japanese Unexamined Patent Publication No. 2016-150860) is exemplified.

Patent Document 1 discloses a method for producing lithium sulfide by synthesizing lithium sulfide with a reaction of lithium hydroxide and hydrogen sulfide, the method including a step (A) of generating a reaction gas containing hydrogen sulfide gas and hydrogen gas by supplying hydrogen gas and sulfur vapor to a porous material which is placed inside a reaction tank and heated, and reacting the hydrogen gas and the sulfur vapor, and a step (B) of producing particulate lithium sulfide by bringing the generated reaction gas into contact with particulate lithium hydroxide to react the hydrogen sulfide gas and the lithium hydroxide. Patent Document 1 discloses that such a production method can reduce the production cost of lithium sulfide, has excellent workability, and can obtain lithium sulfide with high purity.

### RELATED DOCUMENT

### Patent Document

Patent Document 1: Japanese Unexamined Patent Publication No. 2016-150860

### SUMMARY OF THE INVENTION

### Technical Problem

However, it has been difficult to achieve sufficiently high production efficiency with the hydrogen sulfide production techniques disclosed in Patent Document 1 and the like. In addition, there is also room for improvement in stability of the production efficiency.

The present invention has been made in view of the above-described circumstances, and an object of the present invention is to provide a hydrogen sulfide producing device capable of stably producing hydrogen sulfide with high efficiency.

### Solution to Problem

According to the present invention, the following hydrogen sulfide producing device and method for producing hydrogen sulfide are provided.

[1]

A hydrogen sulfide producing device for producing hydrogen sulfide by reacting sulfur vapor with hydrogen gas, the hydrogen sulfide producing device including:
a reactor having a liquid sulfur filling part inside;
a first heating unit for heating liquid sulfur to produce the sulfur vapor; and
a hydrogen supply member connected to the reactor.
   [2]

The hydrogen sulfide producing device according to [1],
in which an interior of the reactor includes a catalyst support member provided above the liquid sulfur filling part and a heat-insulating member provided above the catalyst support member,
the hydrogen sulfide producing device further includes a second heating unit for heating a space formed by the catalyst support member, the heat-insulating member, and an inner wall of the reactor, and
an upper space and a lower space of the heat-insulating member communicate with each other in a part of the heat-insulating member or around the heat-insulating member.
   [3]

The hydrogen sulfide producing device according to [2],
in which the heat-insulating member is a metal substrate or a ceramic substrate, which is provided with a communication hole.
   [4]

The hydrogen sulfide producing device according to [2] or [3], further including:
a heat transfer member disposed in contact with or in close proximity to a lower surface of the catalyst support member.
   [5]

The hydrogen sulfide producing device according to any one of [2] to [4],
in which an inner surface of the device is anti-sulfurized.
   [6]

The hydrogen sulfide producing device according to [1],
in which an interior of the reactor includes a catalyst support member provided above the liquid sulfur filling part and a heat-insulating member provided between the catalyst support member and the liquid sulfur filling part,
the hydrogen sulfide producing device further includes a second heating unit for heating the catalyst support member and an upper space of the catalyst support member, and
an upper space and a lower space of the heat-insulating member communicate with each other in a part of the heat-insulating member or around the heat-insulating member.
   [7]

The hydrogen sulfide producing device according to [6],
in which the heat-insulating member is a metal substrate or a ceramic substrate, which is provided with a communication hole.
   [8]

The hydrogen sulfide producing device according to [6] or [7], further including:
a heat transfer member disposed in contact with or in close proximity to a lower surface of the catalyst support member.
   [9]

The hydrogen sulfide producing device according to any one of [6] to [8],
in which an inner surface of the device is anti-sulfurized.
   [10]

The hydrogen sulfide producing device according to [1], further including:
a liquid sulfur supply member connected to the liquid sulfur filling part,
in which an interior of the reactor includes a catalyst support member provided above the liquid sulfur filling part, and
the hydrogen sulfide producing device further includes a second heating unit for heating a space formed by the catalyst support member and an inner wall of the reactor.
   [11]

The hydrogen sulfide producing device according to [10], further including:
a sulfur container; and
a sulfur container heating unit for heating the sulfur container,
in which the sulfur container and the liquid sulfur filling part are connected by the liquid sulfur supply member.
   [12]

The hydrogen sulfide producing device according to [10] or [11],
in which the liquid sulfur supply member includes a backflow prevention gas supply member for preventing backflow of hydrogen sulfide gas.
   [13]

The hydrogen sulfide producing device according to any one of [10] to [12], further including:
a heat transfer member disposed in contact with or in close proximity to a lower surface of the catalyst support member.
   [14]

The hydrogen sulfide producing device according to any one of [10] to [13],
in which an inner surface of the device is anti-sulfurized.
   [15]

A method for producing hydrogen sulfide, including:
reacting sulfur vapor with hydrogen gas using the hydrogen sulfide producing device according to any one of [1] to [14].

### Advantageous Effects of Invention

According to the present invention, it is possible to provide a hydrogen sulfide producing device with excellent production efficiency.

### BRIEF DESCRIPTION OF THE DRAWINGS

FIG. 1-1 is a vertical cross-sectional view of a hydrogen sulfide producing device according to an embodiment 1-1.

FIG. 1-2 is a top view of a heat-insulating member of the hydrogen sulfide producing device according to the embodiment 1-1.

FIG. 1-3 is a top view of a catalyst support member of the hydrogen sulfide producing device according to the embodiment 1-1.

FIG. 1-4 is a vertical cross-sectional view of a hydrogen sulfide producing device according to an embodiment 1-2.

FIG. 1-5 is a vertical cross-sectional view of a hydrogen sulfide producing device of Reference Example 1.

FIG. 1-6 is a graph showing temperatures inside reactors of hydrogen sulfide producing devices of Example 1 and Reference Example 1.

FIG. 2-1 is a vertical cross-sectional view of a hydrogen sulfide producing device according to an embodiment 2-1.

FIG. 2-2 is a top view of a heat-insulating member of the hydrogen sulfide producing device according to the embodiment 2-1.

FIG. 2-3 is a top view of a catalyst support member of the hydrogen sulfide producing device according to the embodiment 2-1.

FIG. 2-4 is a vertical cross-sectional view of a hydrogen sulfide producing device according to an embodiment 2-2.

FIG. 3-1 is a vertical cross-sectional view of a hydrogen sulfide producing device according to an embodiment 3-1.

FIG. 3-2 is a top view of a catalyst support member of the hydrogen sulfide producing device according to the embodiment 3-1.

FIG. 3-3 is a vertical cross-sectional view of a hydrogen sulfide producing device according to an embodiment 3-2.

### DESCRIPTION OF EMBODIMENTS

Hereinafter, embodiments of the present invention will be described with reference to the drawings. In all the drawings, the same components are represented by common reference numerals, and the description thereof will not be repeated.

The hydrogen sulfide producing device of the present invention is a hydrogen sulfide producing device for producing hydrogen sulfide by reacting sulfur vapor with hydrogen gas, the hydrogen sulfide producing device including a reactor having a liquid sulfur filling part inside, a first heating unit for heating liquid sulfur to produce the sulfur vapor, and a hydrogen supply member connected to the reactor.

Since the hydrogen sulfide producing device of the present invention includes the reactor having a liquid sulfur filling part inside, according to the hydrogen sulfide producing device of the present invention, sulfur vapor is generated from liquid sulfur filled in the liquid sulfur filling part.

As a result, it is possible to precisely control the amount of sulfur vapor generated, and to achieve higher production efficiency. In addition, by precisely controlling the amount of sulfur vapor generated, it is possible to stably maintain the high production efficiency.

### Embodiment 1-1

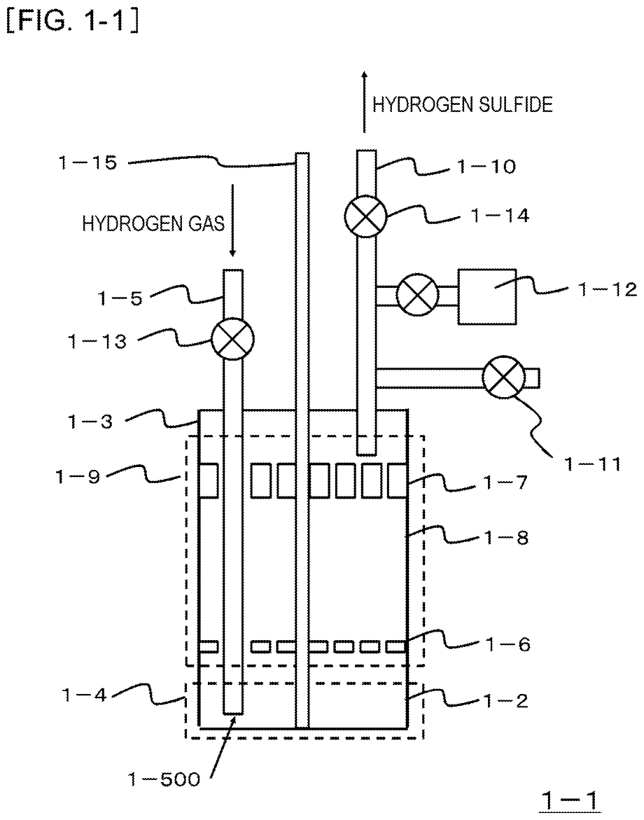

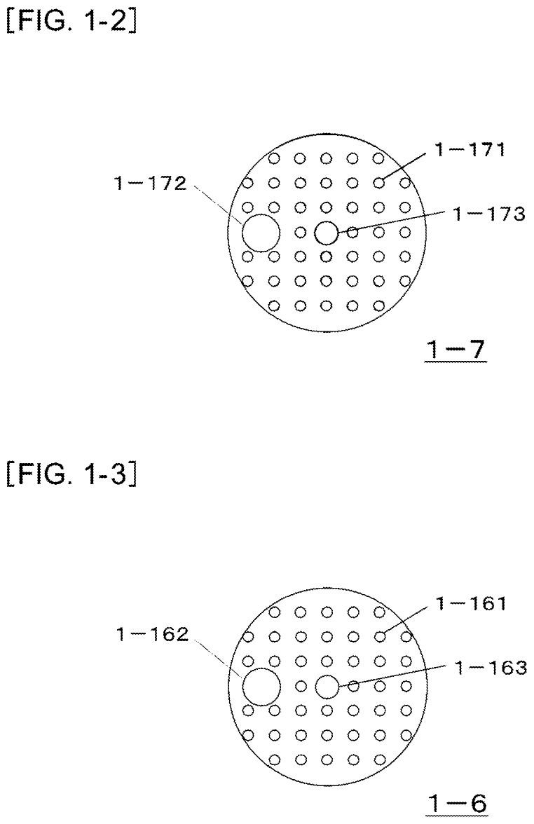

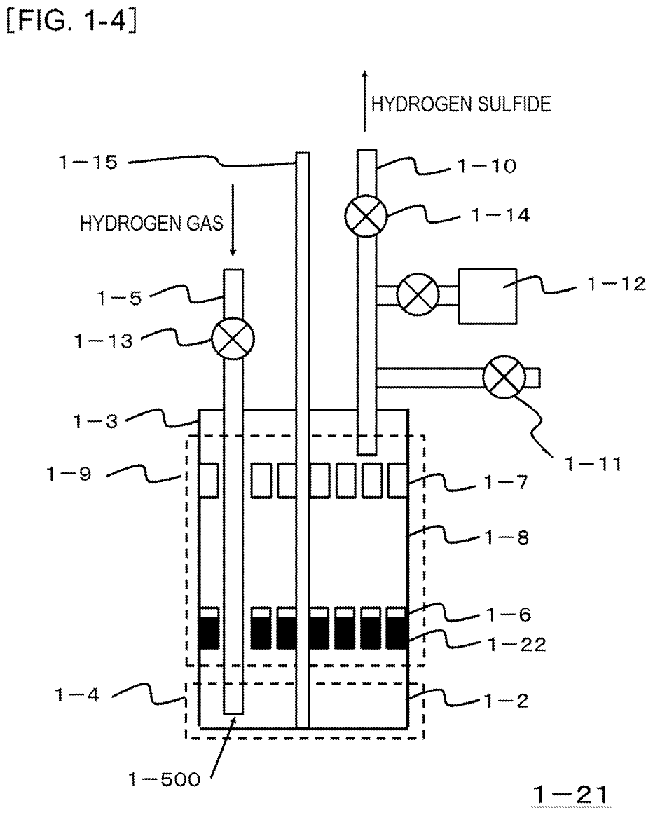

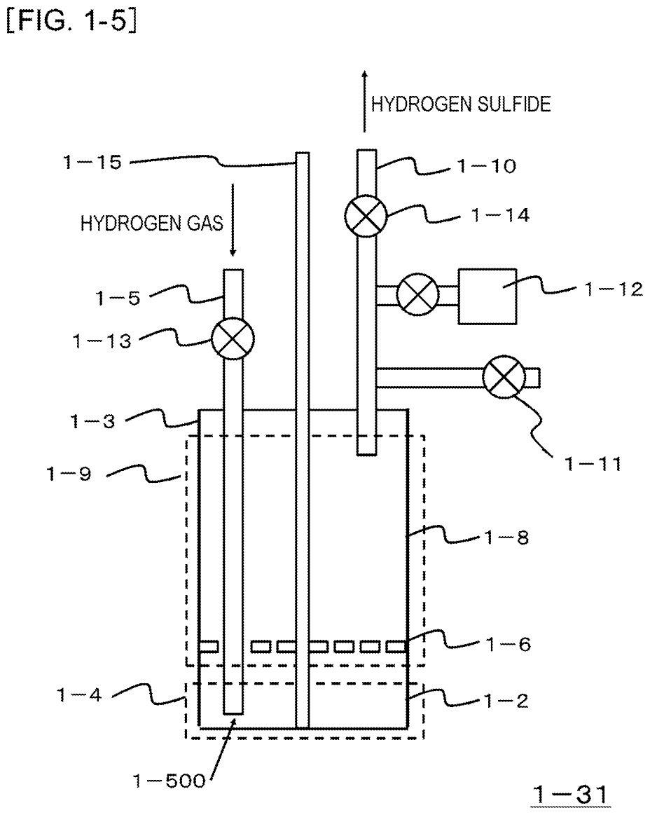

An example of the hydrogen sulfide producing device of the present embodiment (embodiment 1-1) is shown in FIG. 1-1.

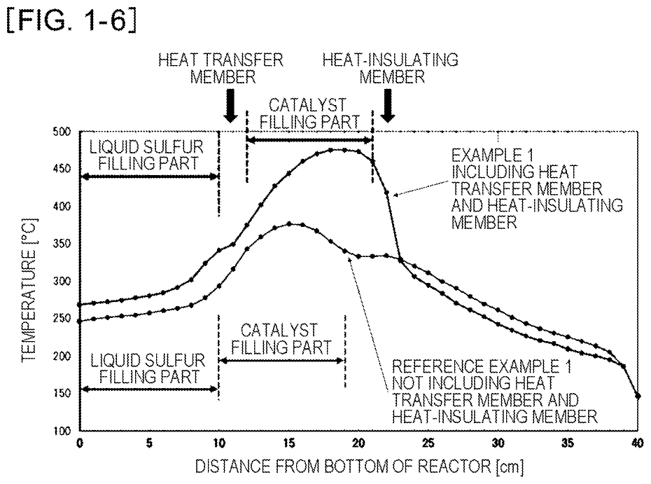

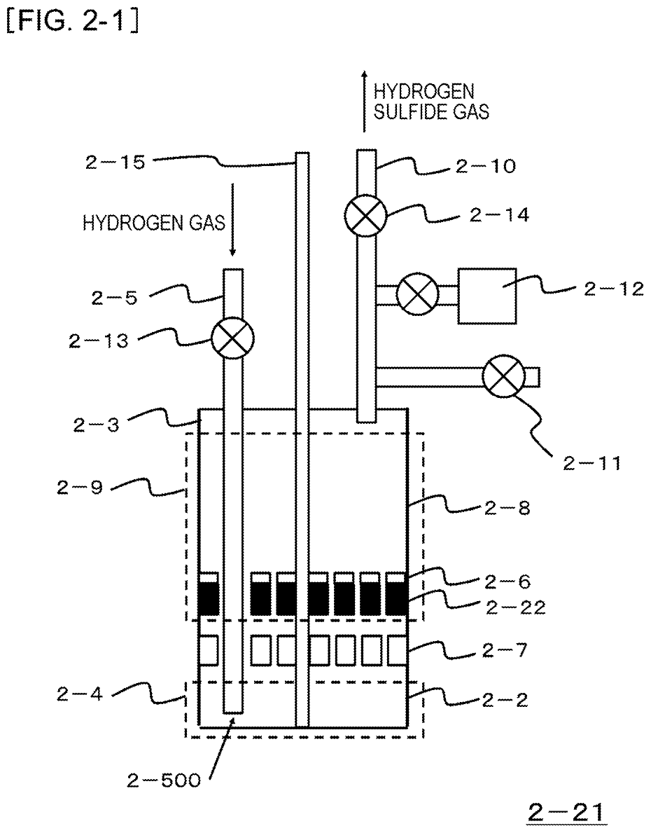

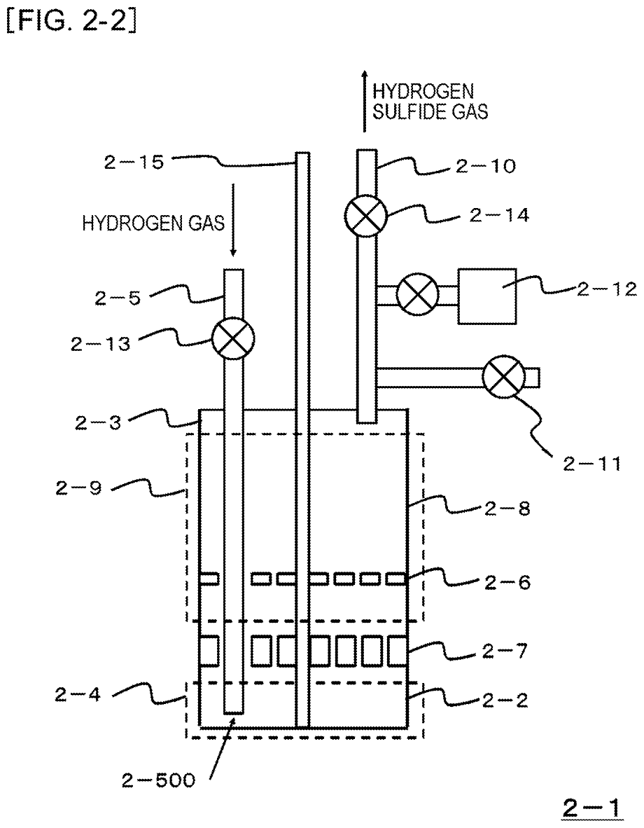

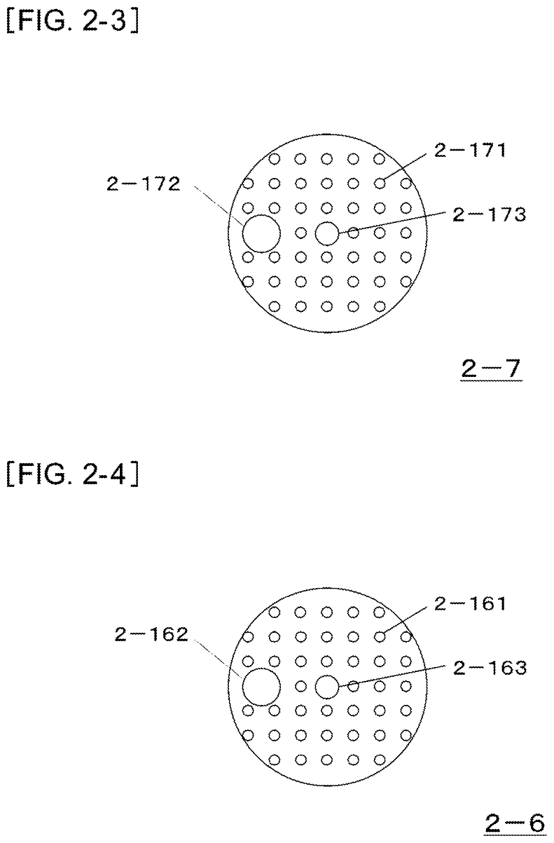

FIG. 1-1 is a vertical cross-sectional view of a hydrogen sulfide producing device 1-1 according to the embodiment 1-1. FIG. 1-2 is a top view of a heat-insulating member 1-7 included in the hydrogen sulfide producing device 1-1. FIG. 1-3 is a top view of a catalyst support member 1-6 included in the hydrogen sulfide producing device 1-1.

The hydrogen sulfide producing device 1-1 of the present embodiment is a device for producing hydrogen sulfide by reacting sulfur vapor with hydrogen gas.

The hydrogen sulfide producing device 1-1 includes a reactor 1-3 having a liquid sulfur filling part 1-2 inside, a mantle heater 1-4 that is a first heating unit for heating liquid sulfur to produce sulfur vapor, and a hydrogen supply pipe 1-5 that is a hydrogen supply member connected to the reactor 1-3.

In an interior of the reactor 1-3, the hydrogen sulfide producing device 1-1 includes a catalyst support member 1-6 provided above the liquid sulfur filling part 1-2 and a heat-insulating member 1-7 provided above the catalyst support member 1-6.

The hydrogen sulfide producing device 1-1 includes a catalyst filling part 1-8 formed by the catalyst support member 1-6, the heat-insulating member 1-7, and an inner wall of the reactor 1-3, and further includes a jacket heater 1-9 that is a second heating unit for heating the catalyst filling part 1-8.

In the interior of the reactor 1-3, an upper space and a lower space of the heat-insulating member 1-7 communicate with each other in a part of the heat-insulating member 1-7 or around the heat-insulating member 1-7.

Sulfur vapor generated in the liquid sulfur filling part 1-2 by the heating of the mantle heater 1-4 is supplied to the catalyst filling part 1-8 through a communication hole 1-161 provided in the catalyst support member 1-6.

The catalyst support member 1-6 is provided with a through hole 1-162 for hydrogen supply pipe, and the hydrogen supply pipe 1-5 is connected to the liquid sulfur filling part 1-2 by passing through the through hole 1-162 for hydrogen supply pipe. In addition, the catalyst support member 1-6 is provided with a through hole 1-163 for temperature sensor, and a temperature sensor 1-15 is connected to the liquid sulfur filling part 1-2 by passing through the through hole 1-163 for temperature sensor.

In addition, the hydrogen gas supplied to the liquid sulfur filling part 1-2 through the hydrogen supply pipe 1-5 is also supplied to the catalyst filling part 1-8 through the communication hole 1-161 provided in the catalyst support member 1-6. The amount of hydrogen gas supplied can be adjusted by a hydrogen supply control valve 1-13 provided in the hydrogen supply pipe 1-5.

The sulfur vapor and the hydrogen gas react with each other in the catalyst filling part 1-8 to generate hydrogen sulfide gas.

The generated hydrogen sulfide gas is supplied to the upper space of the heat-insulating member 1-7 through a portion where the upper space and the lower space of the heat-insulating member 1-7 communicated with each other, and is recovered by a hydrogen sulfide recovery pipe 1-10 that is a hydrogen sulfide recovery member connected to the upper space of the heat-insulating member 1-7. The amount of hydrogen sulfide gas recovered can be adjusted by a hydrogen sulfide recovery control valve 1-14 provided in the hydrogen sulfide recovery pipe 1-10.

The hydrogen sulfide recovery pipe 1-10 is provided with a pressure control valve 1-11, and an internal pressure of the reactor 1-3 can be adjusted by opening and closing the pressure control valve 1-11. In addition, the hydrogen sulfide recovery pipe 1-10 is provided with a hydrogen sulfide detector 1-12 which can detect the flow rate of the hydrogen sulfide.

The present inventor conducted various studies on the reason why the production efficiency of hydrogen sulfide and the stability of output of hydrogen sulfide are not sufficient in the hydrogen sulfide producing device of the related art. As a result, it is found that, by highly controlling a temperature distribution inside the catalyst filling part 1-8 which is a site of hydrogen sulfide generation reaction, the hydrogen sulfide can be stably produced with high efficiency. The present invention has been made based on such findings.

Since the hydrogen sulfide producing device 1-1 of the present embodiment is provided with the heat-insulating member 1-7 in an upper portion of the device, heat is prevented from being released from the upper portion of the hydrogen sulfide producing device 1-1, and the entire temperature inside the catalyst filling part 1-8 which is the site of hydrogen sulfide generation reaction is kept high. Therefore, the temperature distribution in the catalyst filling part 1-8 can be highly controlled. As a result, according to the hydrogen sulfide producing device 1-1 of the present embodiment, the hydrogen sulfide can be stably produced with high efficiency.

Hereinafter, the configuration of each part included in the hydrogen sulfide producing device 1-1 of the present embodiment will be described.

### (Reactor 1-3)

In the reactor 1-3, the hydrogen sulfide is produced by the reaction between the hydrogen gas and the sulfur vapor.

The reactor 1-3 includes the catalyst support member 1-6 provided above the liquid sulfur filling part 1-2 and the heat-insulating member 1-7 provided above the catalyst support member 1-6.

The sulfur vapor generated in the liquid sulfur filling part 1-2 is supplied to a space (catalyst filling part 1-8) surrounded by the catalyst support member 1-6, the heat-insulating member 1-7, and an inner wall of the reactor 1-3, and the sulfur vapor and the hydrogen gas react with each other in the catalyst filling part 1-8 to produce the hydrogen sulfide.

The reactor 1-3 is connected to the hydrogen supply pipe 1-5, and the hydrogen gas is supplied from the hydrogen supply pipe 1-5.

It is preferable that the hydrogen supply pipe 1-5 is disposed so that a hydrogen supply port 1-500 which is an outlet of the hydrogen gas is positioned below to the catalyst support member 1-6. This is because, since the hydrogen gas has a lower specific gravity than air, the hydrogen gas is supplied from below to the catalyst support member 1-6, so that the hydrogen gas can be ventilated upwardly of the reactor 1-3 and efficiently come into contact with a catalyst filled in the catalyst filling part 1-8. In addition, fresh hydrogen gas is continuously supplied by continuously ventilating the hydrogen gas upwardly of the reactor 1-3.

As shown in FIG. 1-2, it is preferable that the heat-insulating member 1-7 is provided with a plurality of communication holes 1-171. By doing so, the sulfur vapor generated in the liquid sulfur filling part 1-2 and the hydrogen gas supplied from the hydrogen supply pipe 1-5 are efficiently supplied to the catalyst filling part 1-8 through the communication holes 1-171.

As shown in FIG. 1-3, it is preferable that the catalyst support member 1-6 is provided with a plurality of communication holes 1-161. By doing so, the sulfur vapor generated in the liquid sulfur filling part 1-2 and the hydrogen gas supplied from the hydrogen supply pipe 1-5 are efficiently supplied to the catalyst filling part 1-8 through the communication holes 1-161.

In the catalyst filling part 1-8, it is preferable that the catalyst is filled in layers to be in contact with an inner wall surface of the reactor 1-3. By doing so, the catalyst can be heated by heat transfer from the inner wall surface of the reactor 1-3, and heating efficiency can be increased.

A temperature of the catalyst filling part 1-8 in all regions is preferably equal to or higher than 300° C., more preferably equal to or higher than 330° C., and still more preferably equal to or higher than 360° C. When the temperature of the catalyst filling part in all regions is equal to or higher than the above-described lower limit value, the hydrogen sulfide can be stably produced with high efficiency.

The temperature of the catalyst filling part 1-8 in all regions is preferably equal to or lower than 500° C., more preferably equal to or lower than 480° C., and still more preferably equal to or lower than 450° C. When the temperature of the catalyst filling part in all regions is equal to or lower than the above-described upper limit value, it is possible to prevent deactivation of the catalyst due to excessive heating and to maintain sulfur resistance of the device.

The temperature of the catalyst filling part 1-8 is usually measured at a horizontal central portion of the catalyst filling part 1-8.

The catalyst filled in the catalyst filling part 1-8 is a catalyst for promoting the hydrogen sulfide generation reaction, and is preferably composed of a material having both resistance to sulfurization and resistance to hydrogenation. For example, the above-described catalyst is composed of one or two or more materials selected from activated carbon, zeolite, and activated alumina. From the viewpoint of reducing impurities, the catalyst is preferably composed of one or two or more materials selected from zeolite and activated alumina, and particularly preferably composed of activated alumina which is inexpensive and highly stable at high temperatures.

In addition, from the viewpoint of promoting the reaction between the hydrogen gas and the sulfur vapor more effectively, metals such as silver, platinum, molybdenum, cobalt, nickel, iron, and vanadium may be carried in pores of the catalyst.

From the viewpoint of preventing corrosion due to sulfur, a material of the reactor 1-3 is preferably composed of one or two or more sulfur-resistant materials selected from quartz, boron nitride, silicon nitride, aluminum, and stainless steel.

In addition, it is preferable that the reactor 1-3 has an anti-sulfurized inner surface of the device.

Examples of a method of sulfur-resistant treatment include plating with metal or alloy with high anti-sulfurization performance, such as tin plating, chrome plating, gold plating, hot-dip aluminum plating, and alloy plating containing these metals.

In addition, a metal diffusion permeation treatment (calorizing treatment) may be used as the method of sulfur-resistant treatment. The calorizing treatment is a treatment for diffusing and permeating a metal such as aluminum into an object to be treated. It is known that, when a metal diffusion permeation layer is formed on a surface of the object to be treated by subjecting the object to the calorizing treatment, the anti-sulfurization performance is improved.

For example, by embedding the object to be treated in a steel case together with a mixture of Fe—Al alloy powder and NH₄Cl powder, sealing the case, and heating it in a furnace, it is possible to form an aluminum diffusion permeation layer in which aluminum is diffused and permeated on the surface of the object to be treated.

### (Mantle Heater 1-4)

In the hydrogen sulfide producing device 1-1 of the present embodiment, the mantle heater 1-4 is used as the first heating unit for heating the liquid sulfur filling part 1-2 to generate the sulfur vapor.

A temperature of the liquid sulfur filling part 1-2 is, for example, equal to or higher than 180° C. and equal to or lower than 445° C., preferably equal to or higher than 250° C. and equal to or lower than 400° C. and more preferably equal to or higher than 300° C. and equal to or lower than 350° C. When the temperature of the liquid sulfur filling part 1-2 is within the above-described range, it is possible to stably generate the sulfur vapor.

A temperature of the mantle heater 1-4 is set such that the temperature of the liquid sulfur filling part 1-2 can be adjusted to the above-described temperature range.

Since the necessary heating temperature changes with a diameter of the liquid sulfur filling part 1-2 and the amount of catalyst filled, the temperature range of the mantle heater 1-4 is not particularly limited, but is preferably equal to or higher than 250° C. and equal to or lower than 400° C. and more preferably equal to or higher than 300° C. and equal to or lower than 350° C.

In the present embodiment, the mantle heater 1-4 is used as the first heating unit, but the present invention is not limited thereto, and any unit may be used as long as it can heat the liquid sulfur filling part 1-2.

### (Hydrogen Supply Pipe 1-5)

The hydrogen supply pipe 1-5 is a member for supplying the hydrogen gas to the reactor 1-3.

It is preferable that the hydrogen supply pipe 1-5 is disposed so that a hydrogen supply port 1-500 which is an outlet of the hydrogen gas is positioned below to the catalyst support member 1-6. This is because, since the hydrogen gas has a lower specific gravity than air, the hydrogen gas is supplied from below to the catalyst support member 1-6, so that the hydrogen gas can be ventilated upwardly of the reactor 1-3 and efficiently come into contact with a catalyst filled in the catalyst filling part 1-8. In addition, fresh hydrogen gas is continuously supplied by continuously ventilating the hydrogen gas upwardly of the reactor 1-3.

The hydrogen supply pipe 1-5 may have a hydrogen supply control valve 1-13 for controlling the amount of hydrogen gas supplied. It is possible to adjust the amount of hydrogen gas supplied by controlling opening and closing of the hydrogen supply control valve 1-13, and this is preferable from the viewpoint of controlling the hydrogen sulfide generation reaction carried out in the reactor 1-3.

As a material of the hydrogen supply pipe 1-5, it is possible to use the material described above as the material of the reactor 1-3.

In the present embodiment, the hydrogen supply pipe 1-5 is used as the hydrogen supply member, but the present invention is not limited thereto, and any hydrogen supply member may be used as long as it can supply the hydrogen gas to the reactor 1-3.

### (Catalyst Support Member 1-6)

The catalyst support member 1-6 is a member for placing the catalyst for promoting the hydrogen sulfide generation reaction, is provided above the liquid sulfur filling part 1-2.

As described above, in order to enable heating by heat transfer from the inner wall surface of the reactor 1-3, it is preferable that the catalyst is filled in layers to be in contact with the inner wall surface of the reactor 1-3. Therefore, it is preferable that the catalyst support member 1-6 is disposed to be in contact with the inner wall surface of the reactor 1-3, so that the catalyst can be placed in this manner.

As shown in FIG. 1-3, it is preferable that the catalyst support member 1-6 is provided with a plurality of communication holes 1-161. By providing a plurality of communication holes 1-161 in the catalyst support member 1-6, the sulfur vapor generated in the liquid sulfur filling part 1-2 and the hydrogen supplied from the hydrogen supply pipe 5 are efficiently supplied to the catalyst filling part 1-8 through the plurality of communication holes 1-161.

The catalyst support member 1-6 may be of any material and shape as long as the catalyst can be placed. Examples of the material of the catalyst support member include metals and ceramics.

As for the shape of the catalyst support member 1-6, it is preferable that the catalyst support member 1-6 is provided with a communication hole such as punching metal. For example, it is possible to use one or two or more porous plates selected from metal mesh such as stainless steel mesh and aluminum mesh, punching metal such as stainless steel punching and aluminum punching, and expanded metal such as expanded stainless steel and expanded aluminum.

As necessary, two or more of the above-described porous plates may be stacked and used as the catalyst support member 1-6.

From the viewpoint of improving contact efficiency between the sulfur vapor and the catalyst, an area ratio of the communication hole 1-161 provided in the catalyst support member 1-6 is usually equal to or more than 10% and equal to or less than 50%, preferably equal to or more than 20% and equal to or less than 40%.

A diameter of the communication hole provided in the catalyst support member 1-6 depends on a diameter of the catalyst to be placed, but is usually equal to or more than 26 μm and equal to or less than 1,000 μm, preferably equal to or more than 45 μm and equal to or less than 800 μm.

The catalyst support member 1-6 may be provided with a through hole 1-162 for hydrogen supply pipe, and in this case, the hydrogen supply pipe 1-5 is connected to the liquid sulfur filling part 1-2 by passing through the through hole 1-162 for hydrogen supply pipe.

In addition, the catalyst support member 1-6 may be provided with a through hole 1-163 for temperature sensor, and in this case, a temperature sensor 1-15 is connected to the liquid sulfur filling part 1-2 by passing through the through hole 1-163 for temperature sensor.

As a material of the catalyst support member 1-6, it is possible to use the material described above as the material of the reactor 1-3.

### (Heat-Insulating Member 1-7)

The heat-insulating member 1-7 is a member for insulating the interior of the reactor 1-3, and is provided above the catalyst support member 1-6.

By providing the heat-insulating member 1-7, heat is prevented from being released from the upper portion of the hydrogen sulfide producing device 1-1, and the entire temperature inside the catalyst filling part 1-8 which is the site of hydrogen sulfide generation reaction is kept high. Therefore, the temperature distribution in the catalyst filling part 1-8 can be highly controlled. As a result, according to the hydrogen sulfide producing device 1-1 of the present embodiment, the hydrogen sulfide can be stably produced with high efficiency.

In the hydrogen sulfide producing device 1-1 of the present embodiment, as compared to a lower portion of the device where the liquid sulfur filling part 1-2 which is a site of sulfur vapor generation exists, the upper portion of the device tends to be more susceptible to temperature drop. Therefore, the use of the heat-insulating member 1-7 to prevent heat release from the upper portion of the hydrogen sulfide producing device 1-1 is an effective method for highly controlling the temperature distribution in the catalyst filling part 1-8.

As shown in FIG. 1-1, it is preferable that the heat-insulating member 1-7 is disposed above the catalyst filling part 1-8 to cover the entire catalyst filling part 1-8. By doing so, the release of heat to the outside of the reactor 1-3 is further prevented.

In addition, as shown in FIG. 1-1, it is preferable that a side surface of the heat-insulating member 1-7 is provided to be in contact with the inner wall of the reactor 1-3. By doing so, the heat-insulating member 1-7 is also heated, and since the heat-insulating member 1-7 itself has a certain heat capacity, heat-insulating effect of the heat-insulating member 1-7 is further enhanced.

In the hydrogen sulfide producing device 1-1 of the present embodiment, an upper space and a lower space of the heat-insulating member 1-7 communicate with each other in a part of the heat-insulating member 1-7 or around the heat-insulating member 1-7. In order to realize such an aspect, it is preferable that the heat-insulating member is a metal substrate or a ceramic substrate, which is provided with a communication hole.

As shown in FIG. 1-2, it is preferable that the heat-insulating member 1-7 is provided with a communication hole 1-171. By providing the communication hole 1-171, the generated hydrogen sulfide moves to the upper portion of the heat-insulating member 1-7 through a plurality of communication holes 1-171, can be recovered by the hydrogen sulfide recovery pipe 1-10 connected to the upper space of the heat-insulating member 1-7.

As the heat-insulating member 1-7, for example, it is possible to use one or two or more porous plates selected from metal mesh such as stainless steel mesh and aluminum mesh, punching metal such as stainless steel punching and aluminum punching, and expanded metal such as expanded stainless steel and expanded aluminum.

As necessary, two or more of the above-described porous plates can be stacked and used as the heat-insulating member 1-7.

From the viewpoint of balance between improvement of heat-insulating efficiency and improvement of hydrogen sulfide recovery, an area ratio of the communication hole provided in the heat-insulating member 1-7 is usually equal to or more than 0.2% and equal to or less than 50%, preferably equal to or more than 0.5% and equal to or less than 40%.

A diameter of the communication hole provided in the heat-insulating member 1-7 is usually equal to or more than 26 pim and equal to or less than 10,000 μm, preferably equal to or more than 45 μm and equal to or less than 5,000 μm.

The heat-insulating member 1-7 may be provided with a through hole 1-172 for hydrogen supply pipe, and in this case, the hydrogen supply pipe 1-5 is connected to the liquid sulfur filling part 1-2 by passing through the through hole 1-172 for hydrogen supply pipe. In addition, the heat-insulating member 1-7 may be provided with a through hole 1-173 for temperature sensor, and in this case, a temperature sensor 1-15 is connected to the liquid sulfur filling part 1-2 by passing through the through hole 1-173 for temperature sensor.

### (Jacket Heater 1-9)

In the hydrogen sulfide producing device 1-1 of the present embodiment, the jacket heater 1-9 is used as the second heating unit. The jacket heater 1-9 heats a space (catalyst filling part 1-8) formed by the catalyst support member, the heat-insulating member, and an inner wall of the reactor. That is, the catalyst support member and the space above the catalyst support member are heated. As a result, the catalyst can be heated to promote the hydrogen sulfide generation reaction.

A temperature of the jacket heater 1-9 is set such that the temperature of the catalyst filling part 1-8 can be adjusted to the above-described temperature range.

Since the necessary heating temperature changes with a diameter of the catalyst filling part 1-8 and the amount of catalyst filled, the temperature range of the jacket heater 1-9 is not particularly limited, but is preferably equal to or higher than 300° C., more preferably equal to or higher than 330° C., and still more preferably equal to or higher than 360° C.

By adjusting the temperature of the jacket heater 1-9 to be equal to or higher than the above-described lower limit value, the hydrogen sulfide can be stably produced with high efficiency.

In addition, the temperature range is preferably equal to or lower than 500° C., more preferably equal to or lower than 480° C., and still more preferably equal to or lower than 450° C.

By adjusting the temperature of the jacket heater 1-9 to be equal to or lower than the above-described upper limit value, it is possible to prevent deactivation of the catalyst due to excessive heating and to maintain sulfur resistance of the device.

In the present embodiment, the jacket heater 1-9 is used as the second heating unit, but the present invention is not limited thereto, and any heating unit may be used as long as it can heat the space formed by the catalyst support member, the heat-insulating member, and the inner wall of the reactor.

### (Hydrogen Sulfide Recovery Pipe 1-10)

In the hydrogen sulfide producing device 1-1 of the present embodiment, the hydrogen sulfide recovery pipe 1-10 is used as a hydrogen sulfide recovery member for recovering hydrogen sulfide gas from the reactor 1-3.

The hydrogen sulfide recovery pipe 1-10 may have a hydrogen sulfide recovery control valve 1-14 for controlling the amount of hydrogen sulfide gas recovered. By controlling opening and closing of the hydrogen sulfide recovery control valve 1-14, the amount of hydrogen sulfide gas recovered can be adjusted, and for example, this is preferable from the viewpoint of being able to control chemical reaction downstream when another reaction device is connected downstream of the hydrogen sulfide producing device.

The hydrogen sulfide recovery pipe 1-10 may be provided with a pressure control valve 1-11. An internal pressure of the reactor 1-3 can be adjusted by opening and closing the pressure control valve 1-11.

In addition, the hydrogen sulfide recovery pipe 1-10 may be provided with a hydrogen sulfide detector 1-12 for detecting the flow rate of hydrogen sulfide.

### (Temperature Sensor 1-15)

The temperature sensor 1-15 is a member for measuring the temperature of each region in the reactor 1-3.

Since the temperature of the reactor 1-3 is usually measured at a horizontal central portion of the reactor 1-3, it is preferable that the temperature sensor 1-15 is disposed in the horizontal central portion of the reactor 1-3.

### Embodiment 1-2

An example of the hydrogen sulfide producing device of the present embodiment (embodiment 1-2) is shown in FIG. 1-4.

FIG. 1-4 is a vertical cross-sectional view of a hydrogen sulfide producing device 1-21 according to the embodiment 1-2.

The hydrogen sulfide producing device 1-21 further includes a heat transfer member disposed in contact with or in close proximity to a lower surface of the catalyst support member.

By providing the heat transfer member 1-22 under the catalyst support member 1-6, the heat from the jacket heater 1-9 covering the outside of the reactor 1-3 can be easily transmitted toward a central direction of the catalyst filling part, and heat uniformity in a horizontal direction of the catalyst filling part is improved.

It is preferable that the heat transfer member 1-22 is disposed to be in contact with an inner wall of the catalyst filling part 1-8. This is for more efficient transmission of heat from the jacket heater 1-9.

It is preferable that the heat transfer member 1-22 is provided with a plurality of communication holes. By providing a plurality of communication holes in the heat transfer member, the sulfur vapor generated in the liquid sulfur filling part 1-2 and the hydrogen gas supplied from the hydrogen supply pipe 1-5 are efficiently supplied to the catalyst filling part 1-8 through the plurality of communication holes.

A material of the heat transfer member 1-22 is not particularly limited, and the materials described above as the material of the reactor 1-3 can be used. However, it is preferable to use a material having excellent resistance to sulfurization and thermal conductivity, and for example, it is preferable to use aluminum, aluminum alloy, aluminum nitride, or the like.

In addition, a shape of the heat transfer member 1-22 is preferably a plate having an appropriate thickness and provided with the communication hole. For example, one or two or more porous plates selected from stainless steel plates or aluminum plates, which have a thickness of equal to or more than 20 mm and are provided with the communication hole, can be used.

As necessary, two or more of the above-described porous plates can be stacked and used as the heat transfer member.

By providing the communication hole in the heat transfer member 1-22, it is possible to improve the contact efficiency between the sulfur vapor supplied from the liquid sulfur filling part 1-2 and the catalyst.

From the viewpoint of improving heat transfer and improving contact efficiency between the sulfur vapor and the catalyst, an area ratio of the communication hole provided in the heat transfer member 1-22 is usually equal to or more than 0.2% and equal to or less than 50%, preferably equal to or more than 0.5% and equal to or less than 40%.

A diameter of the communication hole provided in the heat transfer member 1-22 is usually equal to or more than 26 μm and equal to or less than 10,000 μm, preferably equal to or more than 45 μm and equal to or less than 5,000 μm.

The heat transfer member 1-22 may be provided with a through hole for hydrogen supply pipe, and in this case, the hydrogen supply pipe 1-5 is connected to the liquid sulfur filling part 1-2 by passing through the through hole for hydrogen supply pipe. In addition, the heat transfer member 1-22 may be provided with a through hole for temperature sensor, and in this case, a temperature sensor 1-15 is connected to the liquid sulfur filling part 1-2 by passing through the through hole for temperature sensor.

### [Method for Producing Hydrogen Sulfide by Hydrogen Sulfide Producing Device of Embodiment 1-1 or 1-2]

A method for producing hydrogen sulfide using the hydrogen sulfide producing device of the embodiment 1-1 or 1-2 will be described.

First, liquid sulfur filled in the liquid sulfur filling part 1-2 is heated by the mantle heater 1-4 to generate sulfur vapor.

A temperature of the liquid sulfur filling part 1-2 is not particularly limited as long as it is a temperature at which the sulfur vapor is generated, but is, for example, equal to or higher than 180° C. and equal to or lower than 445° C., preferably equal to or higher than 250° C. and equal to or lower than 400° C. and more preferably equal to or higher than 300° C. and equal to or lower than 350° C.

When the temperature of the liquid sulfur filling part 1-2 is equal to or higher than the above-described lower limit value, since a sulfur vapor pressure is more moderate and a concentration of the obtained hydrogen sulfide gas increases, the hydrogen sulfide can be produced more efficiently. When the temperature of the liquid sulfur filling part 1-2 is equal to or lower than the above-described upper limit value, the sulfur vapor pressure can be reduced to equal to or less than 1 atom, and the amount of sulfur passing through the reactor without reacting with the hydrogen gas can be reduced.

In the production process of the hydrogen sulfide using the hydrogen sulfide producing device of the present embodiment, by supplying the sulfur vapor and the hydrogen gas to the catalyst heated by the jacket heater 1-9, the hydrogen gas and the sulfur vapor react on the surface of the catalyst to generate hydrogen sulfide gas.

At this time, by supplying an excessive amount of the hydrogen gas, it is possible to recover hydrogen sulfide gas in a state diluted with the hydrogen gas. As a result, since a concentration of hydrogen sulfide gas contained in an exhaust gas which is generated during pressure adjustment, reaction termination, and the like can be reduced, exhaust gas treatment can be performed more simply.

The concentration of hydrogen sulfide gas during recovery is preferably equal to or more than 1% by volume, and more preferably equal to or more than 3% by volume. In addition, the concentration of hydrogen sulfide gas during recovery is preferably equal to or less than 50% by volume, and more preferably equal to or less than 30% by volume.

In the production process of the hydrogen sulfide using the hydrogen sulfide producing device of the present embodiment, since the heat-insulating member 1-7 is provided on the upper portion of the hydrogen sulfide producing device 1-1, a temperature drop in a region far from the liquid sulfur filling part 1-2 (generation source of the hydrogen sulfide gas) provided at the lower portion of the device is prevented, and the temperature of the entire catalyst filling part 1-8 is kept high. As a result, the temperature of the catalyst which is a site of the hydrogen sulfide generation reaction can be highly controlled, the hydrogen sulfide can be stably produced with high efficiency.

A temperature of the catalyst filling part 1-8 in all regions is preferably equal to or higher than 300° C., more preferably equal to or higher than 330° C., and still more preferably equal to or higher than 360° C.

When the temperature of the catalyst filling part 1-8 in all regions is equal to or higher than the above-described lower limit value, the hydrogen sulfide can be stably produced with high efficiency.

The temperature of the catalyst filling part 1-8 in all regions is preferably equal to or lower than 500° C., more preferably equal to or lower than 480° C., and still more preferably equal to or lower than 450° C.

When the temperature of the catalyst filling part 1-8 in all regions is equal to or lower than the above-described upper limit value, it is possible to prevent deactivation of the catalyst due to excessive heating and to maintain sulfur resistance of the device.

### Embodiment 2-1

An example of the hydrogen sulfide producing device of the present embodiment (embodiment 2-1) is shown in FIG. 2-1.

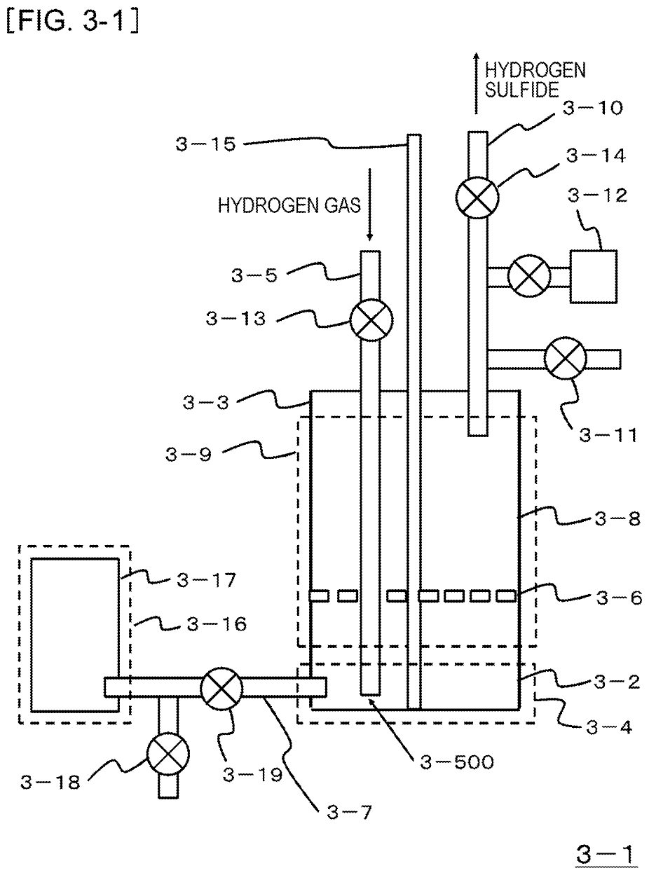

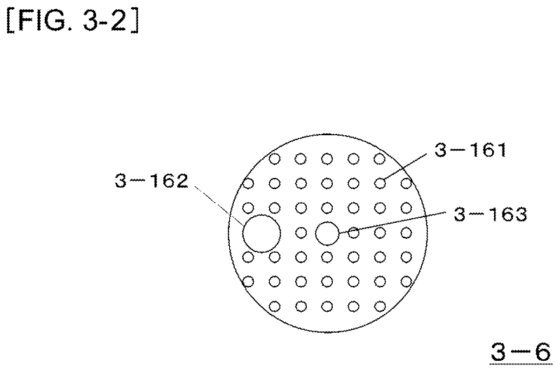

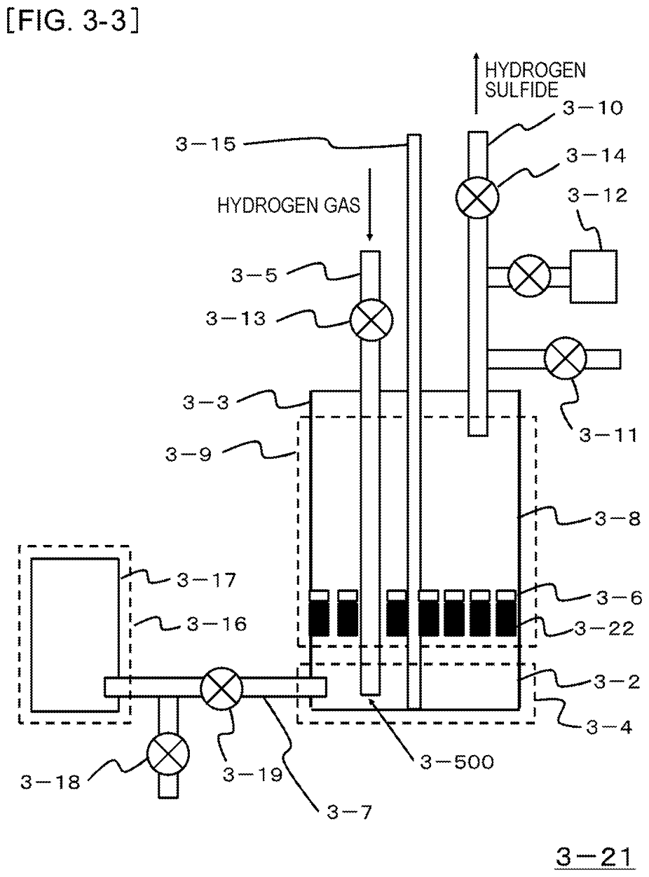

FIG. 2-1 is a vertical cross-sectional view of a hydrogen sulfide producing device 2-1 according to the embodiment 2-1. FIG. 2-2 is a top view of a heat-insulating member 2-7 included in the hydrogen sulfide producing device 2-1. FIG. 2-3 is a top view of a catalyst support member 2-6 included in the hydrogen sulfide producing device 2-1.

The hydrogen sulfide producing device 2-1 of the present embodiment is a device for producing hydrogen sulfide by reacting sulfur vapor with hydrogen gas.

The hydrogen sulfide producing device 2-1 includes a reactor 2-3 having a liquid sulfur filling part 2-2 inside, a mantle heater 2-4 that is a first heating unit for heating liquid sulfur to produce sulfur vapor, and a hydrogen supply pipe 2-5 that is a hydrogen supply member connected to the reactor 2-3.

An interior of the reactor 2-3 is provided with a catalyst support member 2-6 provided above the liquid sulfur filling part 2-2 and a heat-insulating member 2-7 provided between the catalyst support member 2-6 and the liquid sulfur filling part 2-2.

The hydrogen sulfide producing device 2-1 includes a jacket heater 2-9 that is a second heating unit for heating the catalyst support member 2-6 and an upper space of the catalyst support member 2-6, and an upper space and a lower space of the heat-insulating member 2-7 communicate with each other in a part of the heat-insulating member 2-7 or around the heat-insulating member 2-7.

In order to generate the sulfur vapor, a temperature of the liquid sulfur filling part 2-2 is usually adjusted to 250° C. to 400° C., preferably 300° C. to 350° C. The temperature of the liquid sulfur filling part 2-2 is usually measured at a horizontal central portion of the liquid sulfur filling part 2-2.

The problem here is that a vapor pressure of sulfur fluctuates exponentially in this temperature range, so that even a deviation of a few degrees cause a large fluctuation in the amount of sulfur vapor generated. Therefore, in order to control the amount of sulfur vapor generated to a desired level and stably produce the hydrogen sulfide with high production efficiency, it is necessary to avoid heat transfer from the reactor 2-3 as much as possible.

Regarding this point, in the hydrogen sulfide producing device 2-1 of the present embodiment, since the heat-insulating member 2-7 is provided between the catalyst support member 2-6 and the liquid sulfur filling part 2-2, heat is prevented from being transferred from the reactor 2-3 to the liquid sulfur filling part 2-2, and the temperature of the liquid sulfur filling part 2-2 is prevented from rising excessively.

Therefore, the amount of sulfuric vapor generated can be controlled to a desired level, and the hydrogen sulfide can be stably produced with high production efficiency.

Hereinafter, the configuration of each part of the hydrogen sulfide producing device of the present embodiment will be described.

### (Reactor 2-3)

In the reactor 2-3, the hydrogen sulfide is produced by the reaction between the hydrogen gas and the sulfur vapor. Specifically, the reactor 2-3 includes a catalyst support member 2-6 provided above the liquid sulfur filling part 2-2 and a heat-insulating member 2-7 provided between the catalyst support member 2-6 and the liquid sulfur filling part 2-2.

The sulfur vapor generated in the liquid sulfur filling part 2-2 is supplied to the upper space of the catalyst support member 2-6. The upper space of the catalyst support member 2-6 is filled with a catalyst.

In the present embodiment, the upper space of the catalyst support member 2-6, filled with the catalyst, is called a catalyst filling part 2-8, and the sulfur vapor and the hydrogen gas react in the catalyst filling part 2-8 to produce hydrogen sulfide.

The reactor 2-3 is connected to the hydrogen supply pipe 2-5, and the hydrogen gas is supplied from the hydrogen supply pipe 2-5.

It is preferable that the hydrogen supply pipe 2-5 is disposed so that a hydrogen supply port 2-500 which is an outlet of the hydrogen gas is positioned below to the catalyst support member 2-6. This is because the hydrogen gas is supplied from below to the catalyst support member 2-6, so that the hydrogen gas can be ventilated upwardly of the reactor 2-3 and efficiently come into contact with the catalyst filled in the catalyst filling part 2-8. In addition, fresh hydrogen gas is continuously supplied by continuously ventilating the hydrogen gas upwardly of the reactor 2-3.

As shown in FIG. 2-2, it is preferable that the heat-insulating member 2-7 is provided with a plurality of communication holes 2-171. By doing so, the sulfur vapor generated in the liquid sulfur filling part 2-2 and the hydrogen gas supplied from the hydrogen supply pipe 2-5 are efficiently supplied to the catalyst filling part 2-8 through the communication holes 2-171.

As shown in FIG. 2-3, it is preferable that the catalyst support member 2-6 is provided with a plurality of communication holes 2-161. By doing so, the sulfur vapor generated in the liquid sulfur filling part 2-2 and the hydrogen gas supplied from the hydrogen supply pipe 2-5 are efficiently supplied to the catalyst filling part 2-8 through the communication holes 2-161.

A catalyst (not shown) is placed on the catalyst support member 2-6 to promote the reaction of hydrogen gas and sulfur vapor to produce hydrogen sulfide.

By doing so, a reaction in which the hydrogen sulfide is produced from the sulfur vapor generated in the liquid sulfur filling part 2-2 and the hydrogen gas supplied from the hydrogen supply pipe 2-5 progresses in the surface of the catalyst filled in the catalyst filling part 2-8.

In the catalyst filling part 2-8, it is preferable that the catalyst is filled in layers to be in contact with an inner wall surface of the reactor 2-3. By doing so, the catalyst can be heated by heat transfer from the inner wall surface of the reactor 2-3, and heating efficiency can be increased.

In order to promote the hydrogen sulfide generation reaction, a temperature of the catalyst filling part 2-8 is usually adjusted to 300° C. to 500° C., preferably 360° C. to 450° C. The temperature of the catalyst filling part 2-8 is usually measured at a horizontal central portion of the catalyst filling part 2-8.

The catalyst filled in the catalyst filling part 2-8 is a catalyst for promoting the hydrogen sulfide generation reaction, and is preferably composed of a material having both resistance to sulfurization and resistance to hydrogenation. For example, the above-described catalyst is composed of one or two or more materials selected from activated carbon, zeolite, and activated alumina. From the viewpoint of reducing the amount of impurities, the catalyst is preferably composed of one or two or more materials selected from zeolite and activated alumina, and particularly preferably composed of activated alumina which is inexpensive and highly stable at high temperatures.

In addition, from the viewpoint of promoting the reaction between the hydrogen gas and the sulfur vapor more effectively, metals such as silver, platinum, molybdenum, cobalt, nickel, iron, and vanadium may be carried in pores of the catalyst.

Examples of a material of the reactor 2-3 include metals and ceramics, and it is preferable to use a sulfur-resistant material. Examples of the sulfur-resistant material include sulfur-resistant metallic materials such as stainless steel and aluminum, and sulfur-resistant ceramic materials such as quartz, boron nitride, and silicon nitride.

It is preferable that the reactor 2-3 has an anti-sulfurized inner surface.

Examples of a method of sulfur-resistant treatment include plating with metal or alloy with high anti-sulfurization performance, such as tin plating, chrome plating, gold plating, hot-dip aluminum plating, and alloy plating containing these metals.

In addition, a metal diffusion permeation treatment may be used as the method of sulfur-resistant treatment. It is known that, when a metal diffusion permeation layer is formed on a surface of the object to be treated by subjecting the object to the metal diffusion permeation treatment, the anti-sulfurization performance is improved.

For example, a calorizing treatment which diffuses and permeates aluminum can be used. In the calorizing treatment, by embedding the object to be treated in a steel case together with a mixture of Fe—Al alloy powder and NH₄Cl powder, sealing the case, and heating it in a furnace, it is possible to form an aluminum diffusion permeation layer in which aluminum is diffused and permeated on the surface of the object to be treated, thereby improving anti-sulfurization performance of the object to be treated.

### (Mantle Heater 2-4)

In the present embodiment, the mantle heater 2-4 is used as the first heating unit.

The mantle heater 2-4 is a unit for heating the liquid sulfur filling part 2-2 in order to generate sulfur vapor.

A temperature of the mantle heater 2-4 is set such that the temperature of the liquid sulfur filling part 2-2 can be adjusted to the above-described temperature range.

Since the necessary heating temperature changes with a diameter of the liquid sulfur filling part 2-2 and the amount of catalyst filled, the temperature range of the mantle heater 2-4 is not particularly limited, but is preferably 250° C. to 400° C. and more preferably 300° C. to 350° C.

In addition, in the present embodiment, the mantle heater 2-4 is used as the first heating unit, but the present invention is not limited thereto, and any unit may be used as long as it can heat the liquid sulfur. For example, a high frequency induction heating device or the like can be used.

### (Hydrogen Supply Pipe 2-5)

The hydrogen supply pipe 2-5 is a member for supplying the hydrogen gas to the reactor 2-3.

It is preferable that the hydrogen supply pipe 2-5 is disposed so that a hydrogen supply port 2-500 which is an outlet of the hydrogen gas is positioned below to the catalyst support member 2-6. This is because the hydrogen gas is supplied from below to the catalyst support member 2-6, so that the hydrogen gas can be ventilated upwardly of the reactor 2-3 and efficiently come into contact with the catalyst filled in the catalyst filling part 2-8. In addition, fresh hydrogen gas is continuously supplied by continuously ventilating the hydrogen gas upwardly of the reactor 2-3.

As shown in FIG. 2-1, the hydrogen supply pipe 2-5 may have a hydrogen supply control valve 2-13 for controlling the amount of hydrogen gas supplied. It is possible to adjust the amount of hydrogen gas supplied by controlling opening and closing of the hydrogen supply control valve 2-13, and this is preferable from the viewpoint of controlling the hydrogen sulfide generation reaction carried out in the reactor 2-3.

As a material of the hydrogen supply pipe 2-5, it is possible to use the material described above as the material of the reactor 2-3.

In addition, in the present embodiment, the hydrogen supply pipe 2-5 is used as the hydrogen supply member, but the present invention is not limited thereto, and any member may be used as long as it can supply the hydrogen gas to the reactor 2-3.

### (Catalyst Support Member 2-6)

The catalyst support member 2-6 is a member for placing the catalyst which promotes the reaction of hydrogen gas and sulfur vapor to produce hydrogen sulfide.

As described above, in order to enable heating by heat transfer from the inner wall surface of the reactor 2-3, it is preferable that the catalyst is filled in layers to be in contact with the inner wall surface of the reactor 2-3. Therefore, it is preferable that the catalyst support member 2-6 is disposed to be in contact with the inner wall surface of the reactor 2-3, so that the catalyst can be placed in this manner.

As shown in FIG. 2-3, it is preferable that the catalyst support member 2-6 is provided with a plurality of communication holes 2-161. By providing a plurality of communication holes 2-161 in the catalyst support member 2-6, the sulfur vapor generated in the liquid sulfur filling part 2-2 and the hydrogen supplied from the hydrogen supply pipe 2-5 are efficiently supplied to the catalyst filling part 2-8 through the plurality of communication holes 2-161.

As shown in FIG. 2-3, the catalyst support member 2-6 may be provided with a through hole 2-162 for hydrogen supply pipe, and in this case, the hydrogen supply pipe 2-5 is connected to the reactor 2-3 by passing through the through hole 2-162 for hydrogen supply pipe.

As shown in FIG. 2-3, the catalyst support member 2-6 may be provided with a through hole 2-163 for temperature sensor, and in this case, the temperature sensor 2-15 is connected to the reactor 2-3 by passing through the through hole 2-163 for temperature sensor. In addition, since the temperature of the reactor 2-3 is usually measured at a horizontal central portion of the reactor 2-3, it is preferable that the through hole 2-163 for temperature sensor is disposed in a horizontal central portion of the catalyst support member 2-6.

As a material of the catalyst support member 2-6, it is possible to use the material described above as the material of the reactor 2-3.

A shape of the catalyst support member 2-6 is not particularly limited as long as the catalyst can be placed thereon, but it is preferable that the catalyst support member 2-6 has a plurality of communication holes 2-161 as described above.

For example, it is possible to use one or two or more porous plates selected from metal mesh such as aluminum mesh and stainless steel mesh, punching metal such as aluminum punching and stainless steel punching, and expanded metal such as expanded aluminum and expanded stainless steel.

As necessary, two or more of the above-described porous plates may be stacked and used as the catalyst support member 2-6.

A diameter of the communication hole 2-161 provided in the catalyst support member 2-6 depends on a diameter of the catalyst to be placed, but is usually equal to or more than 26 μm and equal to or less than 1,000 μm, preferably equal to or more than 45 μm and equal to or less than 800 μm.

### (Heat-Insulating Member 2-7)

The heat-insulating member 2-7 is a member for preventing heat transfer from the reactor 2-3 to the liquid sulfur filling part 2-2, and is provided between the catalyst support member 2-6 and the liquid sulfur filling part 2-2.

As shown in FIG. 2-2, the heat-insulating member 2-7 is preferably a disk-shaped member. In addition, as shown in FIG. 2-1, it is preferable that the disk-shaped heat-insulating member 2-7 is located between the catalyst support member 2-6 and the liquid sulfur filling part 2-2 to cover the entire liquid sulfur filling part 2-2. By doing so, heat is further prevented from being transferred from the reactor 2-3 to the liquid sulfur filling part 2-2, and the temperature of the liquid sulfur filling part 2-2 is prevented from rising excessively. Therefore, it is possible to control the concentration of sulfur vapor to a desired concentration, and to stably produce the hydrogen sulfide with high production efficiency.

As shown in FIG. 2-2, it is preferable that the heat-insulating member 2-7 is provided with a plurality of communication holes 2-171. By providing a plurality of communication holes 2-171 in the heat-insulating member 2-7, the sulfur vapor generated in the liquid sulfur filling part 2-2 and the hydrogen supplied from the hydrogen supply pipe 2-5 are efficiently supplied to the catalyst filling part 2-8 through the plurality of communication holes 2-171.

As shown in FIG. 2-2, the heat-insulating member 2-7 may be provided with a through hole 2-172 for hydrogen supply pipe, and in this case, the hydrogen supply pipe 2-5 is connected to the reactor 2-3 by passing through the through hole 2-172 for hydrogen supply pipe.

As shown in FIG. 2-2, the heat-insulating member 2-7 may be provided with a through hole 2-173 for temperature sensor, and in this case, the temperature sensor 2-15 is connected to the reactor 2-3 by passing through the through hole 2-173 for temperature sensor. In addition, since the temperature of the reactor 2-3 is usually measured at a horizontal central portion of the reactor 2-3, it is preferable that the through hole 2-173 for temperature sensor is disposed in a horizontal central portion of the heat-insulating member 2-7.

As a material of the heat-insulating member 2-7, it is possible to use the material described above as the material of the reactor 2-3.

A shape of the heat-insulating member 2-7 is not particularly limited, but it is preferable that the heat-insulating member 2-7 has a plurality of communication holes 2-171 as described above. For example, it is possible to use one or two or more porous plates selected from metal mesh such as aluminum mesh and stainless steel mesh, punching metal such as aluminum punching and stainless steel punching, and expanded metal such as expanded aluminum and expanded stainless steel.

As necessary, two or more of the above-described porous plates may be stacked and used as the heat-insulating member 2-7.

From the viewpoint of balance between improvement of heat-insulating efficiency and improvement of supply efficiency of sulfur vapor and hydrogen gas, an area ratio of the communication hole 2-171 provided in the heat-insulating member 2-7 is usually equal to or more than 0.2% and equal to or less than 50%, preferably equal to or more than 0.5% and equal to or less than 40%.

From the viewpoint of balance between improvement of heat-insulating efficiency and improvement of supply efficiency of sulfur vapor and hydrogen gas, a diameter of the communication hole 2-171 provided in the heat-insulating member 2-7 is usually equal to or more than 26 μm and equal to or less than 10,000 μm, preferably equal to or more than 45 μm and equal to or less than 5,000 μm.

From the viewpoint of improving heat-insulating efficiency, a thickness of the heat-insulating member 2-7 is preferably equal to or more than 0.5 mm, and more preferably equal to or more than 1.5 mm. In addition, there is no particular upper limit to the thickness of the heat-insulating member 2-7, but the thickness thereof is usually equal to or less than 20 mm.

### (Jacket Heater 2-9)

In the present embodiment, the jacket heater 2-9 is used as the second heating unit.

The jacket heater 2-9 heats the catalyst support member 2-6 and the space above the catalyst support member 2-6. As a result, the catalyst filled in the catalyst filling part 2-8 is heated, and the hydrogen sulfide generation reaction can be promoted.

A temperature of the jacket heater 2-9 is set such that the temperature of the catalyst filling part 2-8 can be adjusted to the above-described temperature range.

Since the necessary heating temperature changes with a diameter of the catalyst filling part 2-8 and the amount of catalyst filled, the temperature range of the jacket heater 2-9 is not particularly limited, but is preferably 300° C. to 500° C. and more preferably 360° C. to 450° C.

In addition, in the present embodiment, the jacket heater 2-9 is used as the second heating unit, but the present invention is not limited thereto, and any unit may be used as long as it can heat the catalyst. For example, a high frequency induction heating device or the like can be used.

### (Hydrogen Sulfide Recovery Pipe 2-10)

The hydrogen sulfide recovery pipe 2-10 is a member for recovering hydrogen sulfide generated by the reaction between sulfur vapor and hydrogen gas.

The hydrogen sulfide recovery pipe 2-10 may be provided with a pressure control valve 2-11, and an internal pressure of the reactor 2-3 can be adjusted by opening and closing the pressure control valve 2-11. In addition, the hydrogen sulfide recovery pipe 2-10 may be provided with a hydrogen sulfide detector 2-12 which is a member for detecting the flow rate of hydrogen sulfide. Furthermore, the hydrogen sulfide recovery pipe 2-10 may be provided with a hydrogen sulfide recovery control valve 2-14 which is a member for controlling the recovery amount of the hydrogen sulfide gas recovered.

### (Temperature Sensor 2-15)

The temperature sensor 2-15 is a member for measuring the temperature of each region in the reactor 2-3.

Since the temperature of the reactor 2-3 is usually measured at a horizontal central portion of the reactor 2-3, it is preferable that the temperature sensor 2-15 is disposed in the horizontal central portion of the reactor 2-3.

In the hydrogen sulfide producing device 2-1 of the present embodiment, since the heat-insulating member 2-7 is provided between the catalyst support member 2-6 and the liquid sulfur filling part 2-2, heat is prevented from being transferred from the reactor 2-3 to the liquid sulfur filling part 2-2, and the temperature of the liquid sulfur filling part 2-2 is prevented from rising excessively. Therefore, it is possible to control the concentration of sulfur vapor to a desired concentration, and to stably produce the hydrogen sulfide with high production efficiency.

### Embodiment 2-2

An example of the hydrogen sulfide producing device of the present embodiment (embodiment 2-2) is shown in FIG. 2-4.

FIG. 2-4 is a vertical cross-sectional view of a hydrogen sulfide producing device 2-21 according to the embodiment 2-2.

The hydrogen sulfide producing device 2-21 further includes a heat transfer member 2-22 disposed in contact with or in close proximity to a lower surface of the catalyst support member 2-6.

By providing the heat transfer member 2-22 under the catalyst support member 2-6, the heat from the jacket heater 2-9 covering the outside of the catalyst filling part 2-8 can be easily transmitted toward a horizontal direction of the catalyst filling part 2-8, and heat uniformity in the horizontal direction of the catalyst filling part 2-8 is improved.

It is preferable that the heat transfer member 2-22 is disposed to be in contact with an inner wall of the catalyst filling part 2-8. This is for more efficient transmission of heat from the jacket heater 2-9.

It is preferable that the heat transfer member 2-22 is provided with a plurality of communication holes. By providing a plurality of communication holes in the heat transfer member, the sulfur vapor generated in the liquid sulfur filling part 2-2 and the hydrogen gas supplied from the hydrogen supply pipe 2-5 are efficiently supplied to the catalyst filling part 2-8 through the plurality of communication holes.

A material of the heat transfer member 2-22 is not particularly limited, and the materials described above as the material of the reactor 2-3 can be used. However, it is preferable to use a material having excellent thermal conductivity, and for example, it is preferable to use aluminum, aluminum alloy, aluminum nitride, or the like.

In addition, a shape of the heat transfer member 2-22 is not particularly limited, but it is preferable that the heat transfer member 2-22 has a plurality of communication holes. For example, one or two or more porous plates selected from stainless steel plates or aluminum plates, which have a thickness of equal to or more than 20 mm and are provided with the communication hole, can be used.

As necessary, two or more of the above-described porous plates may be stacked and used as the heat transfer member 2-22.

From the viewpoint of balance between improvement of heat transfer efficiency and improvement of supply efficiency of sulfur vapor and hydrogen gas, an area ratio of the communication hole provided in the heat transfer member 2-22 is usually equal to or more than 0.2% and equal to or less than 50%, preferably equal to or more than 0.5% and equal to or less than 40%.

A diameter of the communication hole provided in the heat transfer member 2-22 is usually equal to or more than 26 μm and equal to or less than 10,000 μm, preferably equal to or more than 45 μm and equal to or less than 5,000 μm.

In the hydrogen sulfide producing device 2-21 of the present embodiment, by providing the heat transfer member 2-22 under the catalyst support member 2-6, the heat from the jacket heater 2-9 covering the outside of the catalyst filling part 2-8 can be easily transmitted toward a horizontal direction of the catalyst filling part 2-8, and heat uniformity in the horizontal direction of the catalyst filling part 2-8 is improved. Therefore, the hydrogen sulfide can be produced more stably with higher production efficiency.

### [Method for Producing Hydrogen Sulfide by Hydrogen Sulfide Producing Device of Embodiment 2-1 or 2-2]

A method for producing hydrogen sulfide using the hydrogen sulfide producing device of the embodiment 2-1 or 2-2 will be described.

First, in the liquid sulfur filling part 2-2, liquid sulfur is heated by the mantle heater 2-4 to generate sulfur vapor.

In order to generate the sulfur vapor, a temperature of the liquid sulfur filling part 2-2 is usually adjusted to 250° C. to 400° C., preferably 300° C. to 350° C. The temperature of the liquid sulfur filling part 2-2 is usually measured at a horizontal central portion of the liquid sulfur filling part 2-2.

The problem here is that a vapor pressure of sulfur fluctuates exponentially in this temperature range, so that even a deviation of a few degrees cause a large fluctuation in the amount of sulfur vapor generated. Therefore, in order to control the amount of sulfur vapor generated to a desired level and stably produce the hydrogen sulfide with high production efficiency, it is necessary to avoid heat transfer from the reactor 2-3 as much as possible.

Regarding this point, in the hydrogen sulfide producing device 2-1 of the present embodiment, since the heat-insulating member 2-7 is provided between the catalyst support member 6 and the liquid sulfur filling part 2-2, heat is prevented from being transferred from the reactor 2-3 to the liquid sulfur filling part 2-2, and the temperature of the liquid sulfur filling part 2-2 is prevented from rising excessively. Therefore, the amount of sulfur vapor generated can be controlled to a desired level, and the hydrogen sulfide can be stably produced with high production efficiency.

In the production process of the hydrogen sulfide using the hydrogen sulfide producing device 2-1, by supplying the sulfur vapor and the hydrogen gas to the catalyst heated by the jacket heater 2-9, the hydrogen gas and the sulfur vapor react on the surface of the catalyst to generate hydrogen sulfide gas.

At this time, by supplying an excessive amount of the hydrogen gas, it is possible to recover hydrogen sulfide gas in a state diluted with the hydrogen gas. As a result, since a concentration of hydrogen sulfide gas contained in an exhaust gas which is generated during pressure adjustment, reaction termination, and the like can be reduced, exhaust gas treatment can be performed more simply.

The concentration of hydrogen sulfide gas during recovery is preferably equal to or more than 1% by volume, and more preferably equal to or more than 3% by volume. In addition, the concentration of hydrogen sulfide gas during recovery is preferably equal to or less than 50% by volume, and more preferably equal to or less than 30% by volume.

In order to promote the hydrogen sulfide generation reaction, a temperature of the catalyst filling part 2-8 is usually adjusted to 300° C. to 500° C., preferably 360° C. to 450° C. The temperature of the catalyst filling part 2-8 is usually measured at a horizontal central portion of the catalyst filling part 2-8.

### Embodiment 3-1

An example of the hydrogen sulfide producing device of the present embodiment (embodiment 3-1) is shown in FIG. 3-1.

FIG. 3-1 is a vertical cross-sectional view of a hydrogen sulfide producing device 3-1 according to the embodiment 3-1. The hydrogen sulfide producing device 3-1 of the present embodiment is a device for producing hydrogen sulfide by reacting sulfur vapor with hydrogen gas. FIG. 3-2 is a top view of an example of a catalyst support member in the hydrogen sulfide producing device of the present embodiment.

The hydrogen sulfide producing device 3-1 includes a reactor 3-3 having a liquid sulfur filling part 3-2 inside, a mantle heater 3-4 that is a first heating unit for heating liquid sulfur to produce sulfur vapor, a hydrogen supply pipe 3-5 that is a hydrogen supply member connected to the reactor 3-3, and a liquid sulfur supply pipe 3-7 that is a liquid sulfur supply member connected to the liquid sulfur filling part 3-2.

An interior of the reactor 3-3 includes a catalyst support member 3-6 provided above the liquid sulfur filling part 3-2. In the interior of the reactor 3-3, a catalyst filling part 3-8 is formed by the catalyst support member 3-6 and an inner wall of the reactor 3-3.

In addition, the reactor 3-3 includes a jacket heater 3-9 that is a second heating unit for heating the catalyst filling part 3-8.

The liquid sulfur supply pipe 3-7 is configured to be able to constantly supply liquid sulfur to the liquid sulfur filling part 3-2. Sulfur vapor is generated by heating the liquid sulfur supplied to the liquid sulfur filling part 3-2 through the liquid sulfur supply pipe 3-7.

Since the liquid sulfur can be constantly supplied, the amount of sulfur vapor generated can be controlled to a desired amount. Therefore, it is possible to control the concentration of sulfur vapor in the catalyst filling part 3-8 which is a site of hydrogen sulfide generation reaction to a desired concentration, and to stably produce the hydrogen sulfide with high production efficiency.

Hereinafter, the configuration of each part of the hydrogen sulfide producing device of the present embodiment will be described.

### (Reactor 3-3)

In the reactor 3-3, the hydrogen sulfide is produced by the reaction between the hydrogen gas and the sulfur vapor. The reactor 3-3 includes the catalyst support member 3-6 provided above the liquid sulfur filling part 3-2.

The sulfur vapor generated in the liquid sulfur filling part 3-2 is supplied to a space (catalyst filling part 3-8) surrounded by the catalyst support member 3-6 and an inner wall of the reactor 3-3, and the sulfur vapor and the hydrogen gas react with each other in the catalyst filling part 3-8 to produce the hydrogen sulfide.

The reactor 3-3 is connected to the hydrogen supply pipe 3-5, and the hydrogen gas is supplied from the hydrogen supply pipe 3-5.

It is preferable that the hydrogen supply pipe 3-5 is disposed so that a hydrogen supply port 3-500 which is an outlet of the hydrogen gas is positioned below to the catalyst support member 3-6. This is because, since the hydrogen gas has a lower specific gravity than air, the hydrogen gas is supplied from below to the catalyst support member 3-6, so that the hydrogen gas can be ventilated upwardly of the reactor 3-3 and efficiently come into contact with a catalyst filled in the catalyst filling part 3-8. In addition, fresh hydrogen gas is continuously supplied by continuously ventilating the hydrogen gas upwardly of the reactor 3-3.

As shown in FIG. 3-2, it is preferable that the catalyst support member 3-6 is provided with a plurality of communication holes 3-161. By doing so, the sulfur vapor generated in the liquid sulfur filling part 3-2 and the hydrogen gas supplied from the hydrogen supply pipe 3-5 are efficiently supplied to the catalyst filling part 3-8 through the communication holes 3-161.

A catalyst (not shown) is placed on the catalyst support member 3-6 to promote the reaction of hydrogen gas and sulfur vapor to produce hydrogen sulfide.

By doing so, a reaction in which the hydrogen sulfide is produced from the sulfur vapor generated in the liquid sulfur filling part 3-2 and the hydrogen gas supplied from the hydrogen supply pipe 3-5 progresses in the surface of the catalyst filled in the catalyst filling part 3-8.

In the catalyst filling part 3-8, it is preferable that the catalyst is filled in layers to be in contact with an inner wall surface of the reactor 3-3. By doing so, the catalyst can be heated by heat transfer from the inner wall surface of the reactor 3-3, and heating efficiency can be increased.

A temperature of the catalyst filling part 3-8 is preferably equal to or higher than 300° C., more preferably equal to or higher than 330° C., and still more preferably equal to or higher than 360° C. When the temperature of the catalyst filling part 3-8 in all regions is equal to or higher than the above-described lower limit value, the hydrogen sulfide can be stably produced with high efficiency.

The temperature of the catalyst filling part 3-8 is preferably equal to or lower than 500° C., more preferably equal to or lower than 480° C., and still more preferably equal to or lower than 450° C. When the temperature of the catalyst filling part 3-8 in all regions is equal to or lower than the above-described upper limit value, it is possible to prevent deactivation of the catalyst due to excessive heating and to maintain sulfur resistance of the device.

The temperature of the catalyst filling part 3-8 is usually measured at a horizontal central portion of the catalyst filling part 3-8.

The catalyst filled in the catalyst filling part 3-8 is a catalyst for promoting the hydrogen sulfide generation reaction, and is preferably composed of a material having both resistance to sulfurization and resistance to hydrogenation. For example, the above-described catalyst is composed of one or two or more materials selected from activated carbon, zeolite, and activated alumina. From the viewpoint of reducing impurities, the catalyst is preferably composed of one or two or more materials selected from zeolite and activated alumina, and particularly preferably composed of activated alumina which is inexpensive and highly stable at high temperatures.

In addition, from the viewpoint of promoting the reaction between the hydrogen gas and the sulfur vapor more effectively, metals such as silver, platinum, molybdenum, cobalt, nickel, iron, and vanadium may be carried in pores of the catalyst.

From the viewpoint of preventing corrosion due to sulfur, a material of the reactor 3-3 is preferably composed of one or two or more sulfur-resistant materials selected from quartz, boron nitride, silicon nitride, aluminum, and stainless steel.

It is preferable that the reactor 3-3 has an anti-sulfurized inner surface.

Examples of a method of sulfur-resistant treatment include plating with metal or alloy with high anti-sulfurization performance, such as tin plating, chrome plating, gold plating, hot-dip aluminum plating, and alloy plating containing these metals.

In addition, a metal diffusion permeation treatment may be used as the method of sulfur-resistant treatment. It is known that, when a metal diffusion permeation layer is formed on a surface of the object to be treated by subjecting the object to the metal diffusion permeation treatment, the anti-sulfurization performance is improved.

For example, a calorizing treatment which diffuses and permeates aluminum can be used. In the calorizing treatment, by embedding the object to be treated in a steel case together with a mixture of Fe—Al alloy powder and NH₄Cl powder, sealing the case, and heating it in a furnace, it is possible to form an aluminum diffusion permeation layer in which aluminum is diffused and permeated on the surface of the object to be treated, thereby improving anti-sulfurization performance of the object to be treated.

### (Mantle Heater 3-4)

In the present embodiment, the mantle heater 3-4 is used as the first heating unit for heating the liquid sulfur filling part 3-2 to generate the sulfur vapor.

The mantle heater 3-4 is a unit for heating the liquid sulfur filling part 3-2 in order to generate sulfur vapor.

A temperature of the liquid sulfur filling part 3-2 is usually equal to or higher than 180° C. and equal to or lower than 445° C., preferably equal to or higher than 250° C. and equal to or lower than 400° C. and more preferably equal to or higher than 300° C. and equal to or lower than 350° C. When the temperature of the liquid sulfur filling part 3-2 is within the above-described range, it is possible to stably generate the sulfur vapor.

The temperature of the liquid sulfur filling part 3-2 is usually measured at a horizontal central portion of the liquid sulfur filling part 3-2.

A temperature of the mantle heater 3-4 is set such that the temperature of the liquid sulfur filling part 3-2 can be adjusted to the above-described temperature range.

Since the necessary heating temperature changes with a diameter of the liquid sulfur filling part 3-2 and the amount of catalyst filled, the temperature range of the mantle heater 3-4 is not particularly limited, but is preferably equal to or higher than 250° C. and equal to or lower than 400° C. and more preferably equal to or higher than 300° C. and equal to or lower than 350° C.

In addition, in the present embodiment, the mantle heater 3-4 is used as the first heating unit, but the present invention is not limited thereto, and any heating unit may be used as long as it can heat the liquid sulfur. For example, a high frequency induction heating device or the like can be used.

### (Hydrogen Supply Pipe 3-5)

The hydrogen supply pipe 3-5 is a member for supplying the hydrogen gas to the reactor 3-3.

It is preferable that the hydrogen supply pipe 3-5 is disposed so that a hydrogen supply port 3-500 which is an outlet of the hydrogen gas is positioned below to the catalyst support member 3-6. This is because, since the hydrogen gas has a lower specific gravity than air, the hydrogen gas is supplied from below to the catalyst support member 3-6, so that the hydrogen gas can be ventilated upwardly of the reactor 3-3 and efficiently come into contact with a catalyst filled in the catalyst filling part 3-8. In addition, fresh hydrogen gas is continuously supplied by continuously ventilating the hydrogen gas upwardly of the reactor 3-3.

As shown in FIG. 3-1, the hydrogen supply pipe 3-5 may have a hydrogen supply control valve 3-13 for controlling the amount of hydrogen gas supplied. It is possible to adjust the amount of hydrogen gas supplied by controlling opening and closing of the hydrogen supply control valve 3-13, and this is preferable from the viewpoint of controlling the hydrogen sulfide generation reaction carried out in the reactor 3-3.

As a material of the hydrogen supply pipe 3-5, it is possible to use the material described above as the material of the reactor 3-3.

In addition, in the present embodiment, the hydrogen supply pipe 3-5 is used as the hydrogen supply member, but the present invention is not limited thereto, and any member may be used as long as it can supply the hydrogen gas to the reactor 3-3.

### (Catalyst Support Member 3-6)

The catalyst support member 3-6 is a member for placing the catalyst which promotes the reaction of hydrogen gas and sulfur vapor to produce hydrogen sulfide.

As described above, in order to enable heating by heat transfer from the inner wall surface of the reactor 3-3, it is preferable that the catalyst is filled in layers to be in contact with the inner wall surface of the reactor 3-3.

Therefore, it is preferable that the catalyst support member 3-6 is disposed to be in contact with the inner wall surface of the reactor 3-3, so that the catalyst can be placed in this manner.

As shown in FIG. 3-2, it is preferable that the catalyst support member 3-6 is provided with a plurality of communication holes 3-161. By providing a plurality of communication holes 3-161 in the catalyst support member 3-6, the sulfur vapor generated in the liquid sulfur filling part 3-2 and the hydrogen supplied from the hydrogen supply pipe 3-5 are efficiently supplied to the catalyst filling part 3-8 through the plurality of communication holes 3-161.

As shown in FIG. 3-2, the catalyst support member 3-6 may be provided with a through hole 3-162 for hydrogen supply pipe, and in this case, the hydrogen supply pipe 3-5 is connected to the reactor 3-3 by passing through the through hole 3-162 for hydrogen supply pipe.

As shown in FIG. 3-2, the catalyst support member 3-6 may be provided with a through hole 3-163 for temperature sensor, and in this case, the temperature sensor 3-15 is connected to the reactor 3-3 by passing through the through hole 3-163 for temperature sensor. In addition, since the temperature of the reactor 3-3 is usually measured at a horizontal central portion of the reactor 3-3, it is preferable that the through hole 3-163 for temperature sensor is disposed in a horizontal central portion of the catalyst support member 3-6.

As a material of the catalyst support member 3-6, it is possible to use the material described above as the material of the reactor 3-3.

A shape of the catalyst support member 3-6 is not particularly limited as long as the catalyst can be placed thereon, but it is preferable that the catalyst support member 3-6 has a plurality of communication holes 3-161 as described above.

For example, it is possible to use one or two or more porous plates selected from metal mesh such as aluminum mesh and stainless steel mesh, punching metal such as aluminum punching and stainless steel punching, and expanded metal such as expanded aluminum and expanded stainless steel.

As necessary, two or more of the above-described porous plates may be stacked and used as the catalyst support member 3-6.

From the viewpoint of improving contact efficiency between the sulfur vapor and the catalyst, an area ratio of the communication hole 3-161 provided in the catalyst support member 3-6 is usually equal to or more than 10% and equal to or less than 50%, preferably equal to or more than 20% and equal to or less than 40%.

A diameter of the communication hole provided in the catalyst support member 3-6 depends on a diameter of the catalyst to be placed, but is usually equal to or more than 26 μm and equal to or less than 1,000 μm, preferably equal to or more than 45 μm and equal to or less than 800 μm.

### (Liquid Sulfur Supply Pipe 3-7)

The liquid sulfur supply pipe 3-7 is a member for supplying liquid sulfur to the liquid sulfur filling part 3-2, and is connected to the liquid sulfur filling part 3-2.

The liquid sulfur supply pipe 3-7 is configured to be able to constantly supply liquid sulfur to the liquid sulfur filling part 3-2. The liquid sulfur supply pipe 3-7 may include a liquid sulfur supply control valve 3-19 for controlling the amount of liquid sulfur supplied.

In addition, the liquid sulfur supply pipe 3-7 may include a backflow prevention gas supply member 3-18 of preventing backflow of hydrogen sulfide gas, and by supplying a backflow prevention gas such as hydrogen gas from the backflow prevention gas supply member 3-18, it is possible to prevent the sulfur vapor generated in the liquid sulfur filling part 3-2 from backflowing through the liquid sulfur supply pipe 3-7 and hindering the supply of liquid sulfur.

A temperature of the liquid sulfur supply pipe 3-7 is preferably equal to or higher than 120° C. and equal to or lower than 160° C., and more preferably equal to or higher than 130° C. and equal to or lower than 150° C. When the temperature of the liquid sulfur supply pipe 3-7 is equal to or higher than the above-described lower limit value, it is possible to move the sulfur in the liquid sulfur supply pipe 3-7 in a liquid state. In addition, when the temperature of the liquid sulfur supply pipe 3-7 is equal to or lower than the above-described upper limit value, it is possible to prevent the sulfur in the liquid sulfur supply pipe 3-7 from becoming rubbery sulfur, and to smoothly supply sulfur.

As a material of the liquid sulfur supply pipe 3-7, it is possible to use the material described above as the material of the reactor 3-3.

In addition, in the present embodiment, the liquid sulfur supply pipe 3-7 is used as the liquid sulfur supply member, but the present invention is not limited thereto, and any member may be used as long as it can supply the liquid sulfur to the liquid sulfur filling part 3-2.

### (Sulfur Container 3-17 and Sulfur Container Heating Unit 3-16)

The hydrogen sulfide producing device 3-1 of the present embodiment includes a sulfur container 3-17 which is a member for storing sulfur to be supplied to the liquid sulfur filling part 3-2 and a sulfur container heating unit 3-16 which is a member for heating the sulfur container 3-17, and it is preferable that the sulfur container 3-17 and the liquid sulfur filling part 3-2 are connected through the liquid sulfur supply pipe 3-7.

Although not particularly shown, the sulfur container 3-17 may further include a sulfur introduction pipe for introducing sulfur into the sulfur container 3-17 from the outside, and may further include a carrier gas introduction pipe for introducing a carrier gas for pushing out the sulfur from the sulfur container 3-17 to the liquid sulfur supply pipe 3-7. In addition, the sulfur container 3-17 may further include a pipe serving as both the sulfur introduction pipe and the carrier gas introduction pipe.

The sulfur in the sulfur container 3-17 is liquefied by being heated by the sulfur container heating unit 3-16, and liquefied sulfur is supplied to the liquid sulfur filling part 3-2 through the liquid sulfur supply pipe 3-7.

A temperature of the sulfur container 3-17 is preferably equal to or higher than 120° C. and equal to or lower than 160° C., and more preferably equal to or higher than 130° C. and equal to or lower than 150° C. When the temperature of the sulfur container 3-17 is equal to or higher than the above-described lower limit value, the sulfur stored in the sulfur container 3-17 can be sufficiently liquefied. In addition, when the temperature of the sulfur container 3-17 is equal to or lower than the above-described upper limit value, it is possible to prevent the sulfur stored in the sulfur container 3-17 from turning into rubbery sulfur, and to smoothly supply the sulfur through the liquid sulfur supply pipe 3-7.

A temperature of the sulfur container heating unit 3-16 is set such that the temperature of the liquid sulfur filling part 3-2 can be adjusted to the above-described temperature range.

Since the necessary heating temperature changes with a diameter of the liquid sulfur filling part 3-2 and the amount of catalyst filled, the temperature range of the sulfur container heating unit 3-16 is not particularly limited, but is preferably equal to or higher than 120° C. and equal to or lower than 160° C. and more preferably equal to or higher than 130° C. and equal to or lower than 150° C.

### (Jacket Heater 3-9)

In the hydrogen sulfide producing device 3-1 of the present embodiment, the jacket heater 3-9 is used as the second heating unit.

The jacket heater 3-9 heats a space (catalyst filling part 3-8) formed by the catalyst support member, the heat-insulating member, and an inner wall of the reactor. That is, the catalyst support member and the space above the catalyst support member are heated. As a result, the catalyst can be heated to promote the hydrogen sulfide generation reaction.

A temperature of the jacket heater 3-9 is set such that the temperature of the catalyst filling part 3-8 can be adjusted to the above-described temperature range.

Since the necessary heating temperature changes with a diameter of the catalyst filling part 3-8 and the amount of catalyst filled, the temperature range of the jacket heater 3-9 is not particularly limited, but is preferably equal to or higher than 300° C., more preferably equal to or higher than 330° C., and still more preferably equal to or higher than 360° C.

By adjusting the temperature of the jacket heater 3-9 to be equal to or higher than the above-described lower limit value, the hydrogen sulfide can be stably produced with high efficiency.

In addition, the temperature range is preferably equal to or lower than 500° C., more preferably equal to or lower than 480° C., and still more preferably equal to or lower than 450° C.

By adjusting the temperature of the jacket heater 3-9 to be equal to or lower than the above-described upper limit value, it is possible to prevent deactivation of the catalyst due to excessive heating and to maintain sulfur resistance of the device.

In addition, in the present embodiment, the jacket heater 3-9 is used as the second heating unit, but the present invention is not limited thereto, and any heating unit may be used as long as it can heat the catalyst. For example, a high frequency induction heating device or the like can be used.

### (Hydrogen Sulfide Recovery Pipe 3-10)

The hydrogen sulfide recovery pipe 3-10 is a member for recovering hydrogen sulfide generated by the reaction between sulfur vapor and hydrogen gas.

The hydrogen sulfide recovery pipe 3-10 may be provided with a pressure control valve 3-11, and an internal pressure of the reactor 3-3 can be adjusted by opening and closing the pressure control valve 3-11. In addition, the hydrogen sulfide recovery pipe 3-10 may be provided with a hydrogen sulfide detector 3-12 which is a member for detecting the flow rate of hydrogen sulfide. Furthermore, the hydrogen sulfide recovery pipe 3-10 may be provided with a hydrogen sulfide recovery control valve 3-14 which is a member for controlling the recovery amount of the hydrogen sulfide gas recovered.

### (Temperature Sensor 3-15)

The temperature sensor 3-15 is a member for measuring the temperature of each region in the reactor 3-3.

Since the temperature of the reactor 3-3 is usually measured at a horizontal central portion of the reactor 3-3, it is preferable that the temperature sensor 3-15 is disposed in the horizontal central portion of the reactor 3-3.

### Embodiment 3-2

An example of the hydrogen sulfide producing device of the present embodiment (embodiment 3-2) is shown in FIG. 3-3.

FIG. 3-3 is a vertical cross-sectional view of a hydrogen sulfide producing device 3-21 according to the embodiment 3-2.

The hydrogen sulfide producing device 3-21 further includes a heat transfer member 3-22 disposed in contact with or in close proximity to a lower surface of the catalyst support member 3-6.

By providing the heat transfer member 3-22 under the catalyst support member 3-6, the heat from the jacket heater 3-9 covering the outside of the catalyst filling part 3-8 can be easily transmitted toward a horizontal direction of the catalyst filling part 3-8, and heat uniformity in the horizontal direction of the catalyst filling part 3-8 is improved.

It is preferable that the heat transfer member 3-22 is disposed to be in contact with an inner wall of the catalyst filling part 3-8. This is for more efficient transmission of heat from the jacket heater 3-9.

It is preferable that the heat transfer member 3-22 is provided with a plurality of communication holes. By providing a plurality of communication holes in the heat transfer member, the sulfur vapor generated in the liquid sulfur filling part 3-2 and the hydrogen gas supplied from the hydrogen supply pipe 3-5 are efficiently supplied to the catalyst filling part 3-8 through the plurality of communication holes.

A material of the heat transfer member 3-22 is not particularly limited, and the materials described above as the material of the reactor 3-3 can be used. However, it is preferable to use a material having excellent resistance to sulfurization and thermal conductivity, and for example, it is preferable to use aluminum, aluminum alloy, aluminum nitride, or the like.

In addition, a shape of the heat transfer member 3-22 is not particularly limited, but it is preferable that the heat transfer member 3-22 has a plurality of communication holes.

For example, one or two or more porous plates selected from stainless steel plates or aluminum plates, which have a thickness of equal to or more than 20 mm and are provided with the communication hole, can be used.

As necessary, two or more of the above-described porous plates may be stacked and used as the heat transfer member 3-22.

From the viewpoint of improving heat transfer and improving contact efficiency between the sulfur vapor and the catalyst, an area ratio of the communication hole provided in the heat transfer member 3-22 is usually equal to or more than 0.2% and equal to or less than 50%, preferably equal to or more than 0.5% and equal to or less than 40%.

A diameter of the communication hole provided in the heat transfer member 3-22 is usually equal to or more than 26 μm and equal to or less than 10,000 μm, preferably equal to or more than 45 μm and equal to or less than 5,000 μm.

In the hydrogen sulfide producing device 3-21 of the present embodiment, by providing the heat transfer member 3-22 under the catalyst support member 3-6, the heat from the jacket heater 3-9 covering the outside of the catalyst filling part 3-8 can be easily transmitted toward a horizontal direction of the catalyst filling part 3-8, and heat uniformity in the horizontal direction of the catalyst filling part 3-8 is improved.

Therefore, the hydrogen sulfide can be produced more stably with higher production efficiency.

### [Method for Producing Hydrogen Sulfide by Hydrogen Sulfide Producing Device of Embodiment 3-1 or 3-2]

A method for producing hydrogen sulfide using the hydrogen sulfide producing device of the embodiment 3-1 or 3-2 will be described.

In the hydrogen sulfide producing device of embodiment 3-1 or 3-2, the liquid sulfur supply pipe 3-7 is configured to be able to constantly supply liquid sulfur to the liquid sulfur filling part 3-2. Sulfur vapor is generated by heating, by the mantle heater 3-4, the liquid sulfur supplied to the liquid sulfur filling part 3-2 through the liquid sulfur supply pipe 3-7.

Since the liquid sulfur can be constantly supplied, the amount of sulfur vapor generated can be controlled to a desired amount. Therefore, it is possible to control the concentration of sulfur vapor in the catalyst filling part 3-8 which is a site of hydrogen sulfide generation reaction to a desired concentration, and to stably produce the hydrogen sulfide with high production efficiency.

The hydrogen sulfide producing device of the embodiment 3-1 or 3-2 includes a sulfur container 3-17 which is a member for storing sulfur to be supplied to the liquid sulfur filling part 3-2 and a sulfur container heating unit 3-16 which is a member for heating the sulfur container 3-17, and it is preferable that the sulfur container 3-17 and the liquid sulfur filling part 3-2 are connected through the liquid sulfur supply pipe 3-7. The sulfur in the sulfur container 3-17 is liquefied by being heated by the sulfur container heating unit 3-16, and liquefied sulfur is supplied to the liquid sulfur filling part 3-2 through the liquid sulfur supply pipe 3-7.

A temperature of the sulfur container 3-17 is preferably equal to or higher than 120° C. and equal to or lower than 160° C., and more preferably equal to or higher than 130° C. and equal to or lower than 150° C. When the temperature of the sulfur container 3-17 is equal to or higher than the above-described lower limit value, the sulfur stored in the sulfur container 3-17 can be sufficiently liquefied. In addition, when the temperature of the sulfur container 3-17 is equal to or lower than the above-described upper limit value, it is possible to prevent the sulfur stored in the sulfur container 3-17 from turning into rubbery sulfur, and to smoothly supply the sulfur through the liquid sulfur supply pipe 3-7.

A temperature of the liquid sulfur filling part 3-2 is usually equal to or higher than 180° C. and equal to or lower than 445° C., preferably equal to or higher than 250° C. and equal to or lower than 400° C. and more preferably equal to or higher than 300° C. and equal to or lower than 350° C. When the temperature of the liquid sulfur filling part 3-2 is within the above-described range, it is possible to stably generate the sulfur vapor.

The temperature of the liquid sulfur filling part 3-2 is usually measured at a horizontal central portion of the liquid sulfur filling part 3-2.

In the production process of the hydrogen sulfide using the hydrogen sulfide producing device of the embodiment 3-1 or 3-2, by supplying the sulfur vapor and the hydrogen gas to the catalyst heated by the jacket heater 3-9, the hydrogen gas and the sulfur vapor react on the surface of the catalyst to generate hydrogen sulfide gas.

At this time, by supplying an excessive amount of the hydrogen gas, it is possible to recover hydrogen sulfide gas in a state diluted with the hydrogen gas. As a result, since a concentration of hydrogen sulfide gas contained in an exhaust gas which is generated during pressure adjustment, reaction termination, and the like can be reduced, exhaust gas treatment can be performed more simply.

The concentration of hydrogen sulfide gas during recovery is preferably equal to or more than 1% by volume, and more preferably equal to or more than 3% by volume. In addition, the concentration of hydrogen sulfide gas during recovery is preferably equal to or less than 50% by volume, and more preferably equal to or less than 30% by volume.

A temperature of the catalyst filling part 3-8 is preferably equal to or higher than 300° C., more preferably equal to or higher than 330° C., and still more preferably equal to or higher than 360° C. When the temperature of the catalyst filling part 3-8 in all regions is equal to or higher than the above-described lower limit value, the hydrogen sulfide can be stably produced with high efficiency.

The temperature of the catalyst filling part 3-8 is preferably equal to or lower than 500° C., more preferably equal to or lower than 480° C., and still more preferably equal to or lower than 450° C. When the temperature of the catalyst filling part 3-8 in all regions is equal to or lower than the above-described upper limit value, it is possible to prevent deactivation of the catalyst due to excessive heating and to maintain sulfur resistance of the device.

The temperature of the catalyst filling part 3-8 is usually measured at a horizontal central portion of the catalyst filling part 3-8.

### Modification Example

The hydrogen sulfide producing device of the present embodiment may include a member other than the members described above.

In addition, each part of the hydrogen sulfide producing device of the present embodiment may be integrally formed.

Another reaction device may connected downstream of the hydrogen sulfide producing device of the present embodiment.

For example, a reaction device of producing sulfides of metal such as lithium may be connected downstream of the hydrogen sulfide producing device of the present embodiment, and the hydrogen sulfide produced by the hydrogen sulfide producing device of the present embodiment may be supplied thereto.

### [Uses of Hydrogen Sulfide]

The hydrogen sulfide obtained by the production process using the hydrogen sulfide producing device of the present embodiment can be used, for example, in reactions for sulfurizing metal such as lithium.

The sulfide obtained by sulfidation using the hydrogen sulfide obtained by the production process using the hydrogen sulfide producing device of the present embodiment can be suitably used, for example, as positive electrode active materials, negative electrode active materials, solid electrolyte materials, and intermediate raw materials for chemicals for batteries.

The embodiments of the present invention have been described above, but these are examples of the present invention and various configurations other than the above can be adopted.

### EXAMPLES

### Example 1

Example 1 is an example of the embodiment 1-2 described above.

A hydrogen sulfide producing device 21 shown in FIG. 1-4, corresponding to the embodiment 1-2, was produced.

Each member used for producing the hydrogen sulfide producing device is as follows.
Reactor 1-3: SUS316 L reaction tube (inner diameter: 133.8 mm, height: 672 mm) with inner wall calorized with aluminum
Hydrogen supply pipe 1-5: SUS316 L pipe (diameter: 15 mm, length: 750 mm) with inner wall calorized with aluminum
Catalyst support member 1-6: aluminum punching metal (diameter: 133 mm, thickness: 0.5 mm, hole diameter: 0.5 mm, area ratio of hole diameter: 27.9%)
Heat-insulating member 1-7: laminate in which one sheet of aluminum punching metal (diameter: 133 mm, thickness: 1.5 mm, hole diameter: 5 mm, area ratio of hole diameter: 32.1%) and one sheet of aluminum punching metal (diameter: 133 mm, thickness: 0.5 mm, hole diameter: 0.5 mm, area ratio of hole diameter: 27.9%) were stacked at intervals of 8 mm
Heat transfer member 1-22: aluminum plate material (diameter: 133 mm, thickness: 20 mm, hole diameter: 5 mm, area ratio of hole diameter: 8.3%)

The reactor 1-3 was filled with 520 g of sulfur (not shown), and the heat transfer member 1-22 was placed above the sulfur-filled top. A region filled with the sulfur in the lower portion of the reactor 1-3 was a liquid sulfur filling part 1-2.

The catalyst support member 1-6 was placed above the heat transfer member 1-22, and 1.1 kg of activated alumina (diameter: 1 to 2 mm, specific surface area: 270 m²/g) (not shown) packed on the catalyst support member 1-6. A region filled with the activated alumina was a catalyst filling part 1-8.

The heat-insulating member 1-7 was placed on the upper portion filled with the activated alumina.

A temperature sensor 1-15 was penetrated from above the reactor 1-3 so that a tip of the temperature sensor 1-15 reached the bottom surface of the reactor 1-3. The temperature sensor 1-15 penetrated through a horizontal central portion of the reactor 1-3. In addition, the hydrogen supply pipe 1-5 was passed through the reactor 1-3 from above, and a hydrogen supply port 1-500 of the hydrogen supply pipe 1-5 reached the liquid sulfur filling part 1-2.

Next, hydrogen gas was introduced from the hydrogen supply pipe 1-5 into the liquid sulfur filling part 1-2 at a flow rate of 1.0 L/min.

Next, the liquid sulfur filling part 1-2 and the catalyst filling part 1-8 were each heated by a mantle heater 1-4 at a temperature of 200° C. and by a jacket heater 1-9 at a temperature of 400° C.

As a result, the sulfur packed in the liquid sulfur filling part 1-2 became liquid, and sulfur vapor was generated from the liquid sulfur. In addition, as a result, the activated alumina packed in the catalyst filling part 1-8 was heated. Hydrogen sulfide gas was generated from the hydrogen gas supplied from the hydrogen supply pipe 1-5 and the generated sulfur vapor.

### Reference Example 1

A hydrogen sulfide producing device 1-31 was produced in the same manner as in Example 1, except that the heat-insulating member 1-7 and the heat transfer member 1-22 were not included, and hydrogen sulfide gas was generated. The configuration of the hydrogen sulfide producing device 1-31 is shown in FIG. 1-5.

FIG. 1-6 shows the temperature of each region of the reactor 1-3, measured by the temperature sensor 1-15 after 150 minutes from the start of heating, in the hydrogen sulfide producing devices of Example 1 and Reference Example 1.

According to FIG. 1-6, in the hydrogen sulfide producing device of Example 1, including the heat-insulating member and the heat transfer member, the temperature of the catalyst filling part exceeded 400° C. On the other hand, in the hydrogen sulfide producing device of Reference Example 1, not including the heat-insulating member and the heat transfer member, the temperature of the catalyst filling part was lower than that of Example 1, and was below 400° C. From this, it is understood that the hydrogen sulfide producing device of the embodiment 1-2 could stably produce hydrogen sulfide with higher efficiency because the interior of the catalyst filling part was maintained at a high temperature.

### REFERENCE SIGNS LIST

1-1 hydrogen sulfide producing device
1-2 liquid sulfur filling part
1-3 reactor
1-4 mantle heater
1-5 hydrogen supply pipe
1-6 catalyst support member
1-7 heat-insulating member
1-8 catalyst filling part
1-9 jacket heater
1-10 hydrogen sulfide recovery pipe
1-11 pressure control valve
1-12 hydrogen sulfide detector
1-13 hydrogen supply control valve
1-14 hydrogen sulfide recovery control valve
1-15 temperature sensor
1-21 hydrogen sulfide producing device
1-22 heat transfer member
1-31 hydrogen sulfide producing device
1-51 communication hole
1-161 communication hole
1-162 through hole for hydrogen supply pipe
1-163 through hole for temperature sensor
1-171 communication hole
1-172 through hole for hydrogen supply pipe
1-173 through hole for temperature sensor
1-500 hydrogen supply port
2-1 hydrogen sulfide producing device
2-2 liquid sulfur filling part
2-3 reactor
2-4 mantle heater
2-5 hydrogen supply pipe
2-6 catalyst support member
2-7 heat-insulating member
2-8 catalyst filling part
2-9 jacket heater
2-10 hydrogen sulfide recovery pipe
2-11 pressure control valve
2-12 hydrogen sulfide detector
2-13 hydrogen supply control valve
2-14 hydrogen sulfide recovery control valve
2-15 temperature sensor
2-21 hydrogen sulfide producing device
2-22 heat transfer member
2-161 communication hole
2-162 through hole for hydrogen supply pipe
2-163 through hole for temperature sensor
2-171 communication hole
2-172 through hole for hydrogen supply pipe
2-173 through hole for temperature sensor
2-500 hydrogen supply port
3-1 hydrogen sulfide producing device
3-2 liquid sulfur filling part
3-3 reactor
3-4 mantle heater
3-5 hydrogen supply pipe
3-6 catalyst support member
3-7 liquid sulfur supply pipe
3-8 catalyst filling part
3-9 jacket heater
3-10 hydrogen sulfide recovery pipe
3-11 pressure control valve
3-12 hydrogen sulfide detector
3-13 hydrogen supply control valve
3-14 hydrogen sulfide recovery control valve
3-15 temperature sensor
3-16 sulfur container heating unit
3-17 sulfur container
3-18 backflow prevention gas supply member
3-19 liquid sulfur supply control valve
3-21 hydrogen sulfide producing device
3-22 heat transfer member
3-161 communication hole
3-162 through hole for hydrogen supply pipe
3-163 through hole for temperature sensor
3-500 hydrogen supply port

This application claims priority based on Japanese Patent Application No. 2021-091943, Japanese Patent Application No. 2021-091944, and Japanese Patent Application No. 2021-091945 filed on May 31, 2021, the entire contents of which are incorporated herein by reference.

Regarding the above-described embodiments of the present invention, the present invention further discloses the following hydrogen sulfide producing device and method for producing hydrogen sulfide.

### [A1]

A hydrogen sulfide producing device for producing hydrogen sulfide by reacting sulfur vapor with hydrogen gas, the hydrogen sulfide producing device including:
a reactor having a liquid sulfur filling part inside;
a first heating unit for heating liquid sulfur to produce the sulfur vapor; and
a hydrogen supply member connected to the reactor,
in which an interior of the reactor includes a catalyst support member provided above the liquid sulfur filling part and a heat-insulating member provided above the catalyst support member,
the hydrogen sulfide producing device further includes a second heating unit for heating a space formed by the catalyst support member, the heat-insulating member, and an inner wall of the reactor, and
an upper space and a lower space of the heat-insulating member communicate with each other in a part of the heat-insulating member or around the heat-insulating member.

### [A2]

The hydrogen sulfide producing device according to [A1],
in which the heat-insulating member is a metal substrate or a ceramic substrate, which is provided with a communication hole.

### [A3]

The hydrogen sulfide producing device according to (All or [A2], further including:
a heat transfer member disposed in contact with or in close proximity to a lower surface of the catalyst support member.

### [A4]

The hydrogen sulfide producing device according to any one of [A1] to [A3],
in which an inner surface of the device is anti-sulfurized.

### [A5]

A method for producing hydrogen sulfide, including:
reacting sulfur vapor with hydrogen gas using the hydrogen sulfide producing device according to any one of [A1] to [A4].

### [B1]

A hydrogen sulfide producing device for producing hydrogen sulfide by reacting sulfur vapor with hydrogen gas, the hydrogen sulfide producing device including:
a reactor having a liquid sulfur filling part inside;
a first heating unit for heating liquid sulfur to produce the sulfur vapor; and
a hydrogen supply member connected to the reactor,
in which an interior of the reactor includes a catalyst support member provided above the liquid sulfur filling part and a heat-insulating member provided between the catalyst support member and the liquid sulfur filling part,
the hydrogen sulfide producing device further includes a second heating unit for heating the catalyst support member and an upper space of the catalyst support member, and
an upper space and a lower space of the heat-insulating member communicate with each other in a part of the heat-insulating member or around the heat-insulating member.

### [B2]

The hydrogen sulfide producing device according to [B1],
in which the heat-insulating member is a metal substrate or a ceramic substrate, which is provided with a communication hole.

### [B3]

The hydrogen sulfide producing device according to [B1] or [B2], further including:
a heat transfer member disposed in contact with or in close proximity to a lower surface of the catalyst support member.

### [B4]

The hydrogen sulfide producing device according to any one of [B1] to [B3],
in which an inner surface of the device is anti-sulfurized.

### [B5]

A method for producing hydrogen sulfide, including:
reacting sulfur vapor with hydrogen gas in the hydrogen sulfide producing device according to any one of [B1] to [B4].

### [C1]

A hydrogen sulfide producing device for producing hydrogen sulfide by reacting sulfur vapor with hydrogen gas, the hydrogen sulfide producing device including:
a reactor having a liquid sulfur filling part inside;
a first heating unit for heating liquid sulfur to produce the sulfur vapor;
a hydrogen supply member connected to the reactor; and
a liquid sulfur supply member connected to the liquid sulfur filling part,
in which an interior of the reactor includes a catalyst support member provided above the liquid sulfur filling part, and
the hydrogen sulfide producing device further includes a second heating unit for heating a space formed by the catalyst support member and an inner wall of the reactor.

### [C2]

The hydrogen sulfide producing device according to [C1], further including:
a sulfur container; and
a sulfur container heating unit for heating the sulfur container,
in which the sulfur container and the liquid sulfur filling part are connected by the liquid sulfur supply member.

### [C3]

The hydrogen sulfide producing device according to [C2],
in which the liquid sulfur supply member includes a backflow prevention gas supply member for preventing backflow of hydrogen sulfide gas.

### [C4]

The hydrogen sulfide producing device according to any one of [C1] to [C3], further including:
a heat transfer member disposed in contact with or in close proximity to a lower surface of the catalyst support member.

### [C5]

The hydrogen sulfide producing device according to any one of [C1] to [C4],
in which an inner surface of the device is anti-sulfurized.

### [C6]

A method for producing hydrogen sulfide, including:
reacting sulfur vapor with hydrogen gas using the hydrogen sulfide producing device according to any one of [C1] to [C5].

1. A hydrogen sulfide producing device for producing hydrogen sulfide by reacting sulfur vapor with hydrogen gas, the hydrogen sulfide producing device comprising:
a reactor having a liquid sulfur filling part inside;
a first heating unit for heating liquid sulfur to produce the sulfur vapor; and
a hydrogen supply member connected to the reactor.

2. The hydrogen sulfide producing device according to claim 1,
wherein an interior of the reactor includes a catalyst support member provided above the liquid sulfur filling part and a heat-insulating member provided above the catalyst support member,
the hydrogen sulfide producing device further comprises a second heating unit for heating a space formed by the catalyst support member, the heat-insulating member, and an inner wall of the reactor, and
an upper space and a lower space of the heat-insulating member communicate with each other in a part of the heat-insulating member or around the heat-insulating member.

3. The hydrogen sulfide producing device according to claim 2,
wherein the heat-insulating member is a metal substrate or a ceramic substrate, which is provided with a communication hole.

4. The hydrogen sulfide producing device according to claim 2, further comprising:
a heat transfer member disposed in contact with or in close proximity to a lower surface of the catalyst support member.

5. The hydrogen sulfide producing device according to claim 2,
wherein an inner surface of the device is anti-sulfurized.

6. The hydrogen sulfide producing device according to claim 1,
wherein an interior of the reactor includes a catalyst support member provided above the liquid sulfur filling part and a heat-insulating member provided between the catalyst support member and the liquid sulfur filling part,
the hydrogen sulfide producing device further comprises a second heating unit for heating the catalyst support member and an upper space of the catalyst support member, and
an upper space and a lower space of the heat-insulating member communicate with each other in a part of the heat-insulating member or around the heat-insulating member.

7. The hydrogen sulfide producing device according to claim 6,
wherein the heat-insulating member is a metal substrate or a ceramic substrate, which is provided with a communication hole.

8. The hydrogen sulfide producing device according to claim 6, further comprising:
a heat transfer member disposed in contact with or in close proximity to a lower surface of the catalyst support member.

9. The hydrogen sulfide producing device according to claim 6,
wherein an inner surface of the device is anti-sulfurized.

10. The hydrogen sulfide producing device according to claim 1, further comprising:
a liquid sulfur supply member connected to the liquid sulfur filling part,
wherein an interior of the reactor includes a catalyst support member provided above the liquid sulfur filling part, and
the hydrogen sulfide producing device further comprises a second heating unit for heating a space formed by the catalyst support member and an inner wall of the reactor.

11. The hydrogen sulfide producing device according to claim 10, further comprising:
a sulfur container; and
a sulfur container heating unit for heating the sulfur container,
wherein the sulfur container and the liquid sulfur filling part are connected by the liquid sulfur supply member.

12. The hydrogen sulfide producing device according to claim 10,
wherein the liquid sulfur supply member includes a backflow prevention gas supply member for preventing backflow of hydrogen sulfide gas.

13. The hydrogen sulfide producing device according to claim 10, further comprising:
a heat transfer member disposed in contact with or in close proximity to a lower surface of the catalyst support member.

14. The hydrogen sulfide producing device according to claim 10,
wherein an inner surface of the device is anti-sulfurized.

15. A method for producing hydrogen sulfide, comprising:
reacting sulfur vapor with hydrogen gas using the hydrogen sulfide producing device according to claim 1.
